(19) United States
(12) Patent Application Publication
(10) Pub. No.: US 2023/0110047 A1
(43) Pub. Date: Apr. 13, 2023

(54) CONSTRAINED OPTIMIZATION USING AN ANALOG PROCESSOR

(71) Applicant: Lightmatter, Inc., Boston, MA (US)

(72) Inventor: Darius Bunandar, Boston, MA (US)

(73) Assignee: Lightmatter, Inc., Boston, MA (US)

(21) Appl. No.: 17/964,889

(22) Filed: Oct. 12, 2022

Related U.S. Application Data
(60) Provisional application No. 63/255,312, filed on Oct. 13, 2021.

(51) Int. Cl. G06J 1/00

(52) U.S. Cl. CPC G06J 1/00; G06F 7/4833

(57) ABSTRACT

Described herein are techniques of using a hybrid analog-digital processor to optimize parameters of a system for an objective under one or more constraints. The techniques involve using the hybrid analog-digital processor to optimizing parameter values of the system. The optimizing comprises: determining, using an analog processor of the hybrid analog-digital processor, a parameter gradient for parameter values of the system based on the objective function and the at least one constraint; and updating the parameter values of the system using the parameter gradient.

### CROSS-REFERENCE TO RELATED APPLICATIONS

This application claims the benefit of U.S. Provisional Application Ser. No. 63/255,312, filed on Oct. 13, 2021, under Attorney Docket No. L0858.70050US00 and entitled “SOLVING CONSTRAINED LINEAR OPTIMIZATION PROBLEM IN AN ANALOG PROCESSOR,” which is incorporated by reference herein in its entirety.

### FIELD

Described herein are techniques of optimizing parameters of a system for an objective under one or more constraints. The techniques use an analog processor to optimize the system under the constraint(s).

### BACKGROUND

A system may have various parameters that determine an output of the system for a respective input. To illustrate, the system may be a machine learning system with learned parameters that are used to generate an output for a respective input. For example, the machine learning system may include a neural network with learned weights that are used to determine an output of the neural network for a respective input. The output of the neural network may be determined using the weights. As another illustrative example, the system may be a control system with one or more gain parameters that are used to determine an actuation signal based on various inputs.

Performance of the system may depend on the configuration of its parameters. For example, performance of a machine learning system comprising a neural network may depend on the learned weights of the neural network. Similarly, performance of a control system may depend on the gain parameters used by the control system.

### BRIEF SUMMARY

Described herein are techniques that enable use of an analog processor in performing constrained optimization in which a system is optimized for an objective under one or more constraints. The techniques optimize parameters of a given system by performing gradient descent. As part of performing gradient descent, the techniques use an analog processor to determine a parameter gradient based on the objective and the constraint(s). The techniques then use the parameter gradient to update the parameters. Use of the analog processor in determining the parameter gradient allows the gradient descent to optimize the parameters more efficiently than if the gradient descent were performed using only digital hardware.

According to some embodiments, a method of using a hybrid analog-digital processor to optimize a system for an objective under one or more constraints is provided. The hybrid analog-digital processor comprises a digital controller and an analog processor. The method comprises: using the hybrid analog-digital processor to perform: obtaining an objective function associated with the objective, the objective function relating sets of parameter values of the system to values providing a measure of performance of the system; and optimizing parameters of the system, the optimizing comprising: determining, using the analog processor, a parameter gradient for parameter values of the system based on the objective function and the at least one constraint; and updating the parameter values of the system using the parameter gradient.

According to some embodiments, an optimization system for optimizing a system for an objective under at least one constraint is provided. The optimization system comprises: a hybrid analog-digital processor comprising a digital controller and an analog processor, the hybrid analog-digital processor configured to: obtain an objective function associated with the objective, the objective function relating sets of parameter values of the system to values providing a measure of performance of the system; and optimize parameters of the system, the optimizing comprising: determining, using the analog processor, a parameter gradient for parameter values of the system based on the objective function and the at least one constraint; and updating the parameter values of the system using the parameter gradient.

According to some embodiments, a non-transitory computer-readable storage medium storing instructions is provided. The instructions, when executed by a hybrid analog-digital processor comprising a digital controller and an analog processor, cause the hybrid analog-digital processor to perform a method of optimizing a system for an objective under at least one constraint. The method comprises: obtaining an objective function associated with the objective, the objective function relating sets of parameter values of the system to values providing a measure of performance of the system; and optimizing parameters of the system, the optimizing comprising: determining, using the analog processor, a parameter gradient for parameter values of the system based on the objective function and the at least one constraint; and updating the parameter values of the system using the parameter gradient.

The foregoing summary is non-limiting.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A is an example optimization system, according to some embodiments of the technology described herein.

FIG. 1B illustrates interaction among components of a hybrid analog-digital processor of the optimization system of FIG. 1A, according to some embodiments of the technology described herein.

FIG. 2 is a flowchart of an example process of optimizing parameters of a system under one or more constraints using a hybrid analog-digital processor, according to some embodiments of the technology described herein.

FIG. 3 is a flowchart of an example process of determining a parameter gradient based on an objective function and constraint(s), according to some embodiments of the technology described herein.

FIG. 4 is a flowchart of another example process of determining a parameter gradient based on an objective function and constraint(s), according to some embodiments of the technology described herein.

FIG. 5 is a flowchart of an example process of optimizing a system, according to some embodiments of the technology described herein.

FIG. 6 is a flowchart of an example process of performing a matrix operation using an analog processor, according to some embodiments of the technology described herein.

FIG. 7 is a flowchart of an example process of performing a matrix operation between two matrices, according to some embodiments of the technology described herein.

FIG. 8 is a diagram illustrating effects of overamplification, according to some embodiments of the technology described herein.

FIG. 9A is an example matrix multiplication operation, according to some embodiments of the technology described herein.

FIG. 9B illustrates use of tiling to perform the matrix multiplication operation of FIG. 9A, according to some embodiments of the technology described herein.

FIG. 10 is a flowchart of an example process of using tiling to perform a matrix operation, according to some embodiments of the technology described herein.

FIG. 11 is a diagram illustrating performance of a matrix multiplication operation, according to some embodiments of the technology described herein.

FIG. 12 is a flowchart of an example process of performing overamplification, according to some embodiments of the technology described herein.

FIG. 13 illustrates amplification by copying of a matrix, according to some embodiments of the technology described herein.

FIG. 14A is a diagram illustrating amplification by distribution of zero pads among different tiles of a matrix, according to some embodiments of the technology described herein.

FIG. 14B is a diagram illustrating amplification by using a copy of a matrix as a pad, according to some embodiments of the technology described herein.

FIG. 15 is an example hybrid analog-digital processor that may be used in some embodiments of the technology described herein.

FIG. 16 is an example computer system that may be used to implement some embodiments of the technology described herein.

### DETAILED DESCRIPTION

Described herein are techniques of using an analog processor to optimize parameters of a system for an objective under one or more constraints. For example, the techniques may be used to perform constrained linear optimization.

Analog processors (e.g., photonic processors) can perform certain operations more efficiently than digital processors. One category of such operations is general matrix-matrix (GEMM) operations. Computations involved in various different systems involve use of GEMM operations. For example, machine learning systems, graphics processing systems, control systems, and/or signals processing systems may heavily rely on GEMM operations. To illustrate, training of a machine learning system and inference using the machine learning system may involve performing GEMM operations. As another illustrative example, determining an output of a control system may involve performing one or more GEMM operations.

Certain limitations of analog processors typically prevent them from being used in various applications. For example, analog processors can only operate with a fixed-point number representation, which may limit use of analog processors in applications requiring dynamic range provided by a floating point number representation (e.g., a 32-bit floating point representation). As another example, analog processors may introduce noise due to physical mechanisms such as Johnson-Nyquist noise and shot noise, and noise introduced by an analog-to-digital converter (ADC) to obtain a digital version of an analog processor's output. These limitations of analog processors have prevented conventional systems from taking advantage of the potential efficiency improvements that are offered by analog processors in performing computations (e.g., to perform GEMM operations).

One particular area in which conventional systems have failed to employ analog processors is in constrained optimization of a system (e.g., constrained linear optimization). In constrained optimization, a system needs to be optimized under one or more constraints. Conventional techniques of optimizing a system under constraint(s) cannot be performed using an analog processor because they typically require dynamic range provided by a floating point number representation and/or perform poorly in the presence of noise in the analog processor. Thus, conventional techniques are unable to take advantage of the potential efficiency improvements of an analog processor.

The inventors have developed techniques that use an analog processor in performing constrained optimization. The techniques enable use of an analog processor by mitigating the effects of noise and use of a fixed bit number representation on the parameter values. By allowing use of an analog processor, the techniques can perform constrained optimization (e.g., constrained linear optimization) more efficiently than conventional techniques that are restricted to using digital hardware.

The techniques optimize parameters of a given system by performing gradient descent. Gradient descent techniques typically employ GEMM operations, which are well-suited for execution by analog processor. The techniques also utilize an adaptive floating-point (ABFP) number representation to transfer values between a floating point representation of a digital processor and a fixed point representation of an analog processor. Use of the ABFP representation in a matrix operation involves scaling an input matrix or portion thereof such that its values are normalized to a range (e.g., [−1, 1]), and then performing matrix operations in the analog domain using the scaled input matrix or portion thereof. An output of the matrix operation performed in the analog domain may then be descaled based on scaling factors used to scale the input matrix. Using the ABFP representation in a matrix operation may reduce loss in precision due to variation of precision among values in a matrix and also reduce quantization error that results from noise. The techniques are capable of performing constrained optimization using a hybrid analog-digital processor with a similar level of precision as techniques that use only digital hardware.

Some embodiments provide techniques of using a hybrid analog-digital processor to optimize a system for an objective under at least one constraint. The hybrid analog-digital analog processor comprises a digital controller and an analog processor. The techniques use the hybrid analog-digital processor to: (1) obtain an objective function associated with the objective, the objective function relating sets of parameter values of the system to values providing a measure of performance of the system; and (2) optimize parameters of the system. The optimizing comprises: (1) determining, using the analog processor, a parameter gradient for parameter values of the system based on the objective function and the at least one constraint; and (2) updating the parameter values of the system using the parameter gradient.

In some embodiments, determining, using the analog processor, the parameter gradient for the parameter values based on the objective function and the at least one constraint comprises: (1) determining, using the analog processor, a plurality of outputs of the system when configured with the parameter values; and (2) determining, using the analog processor, the parameter gradient using the plurality of outputs of the system configured with the parameter values. In some embodiments, determining, using the analog processor, the parameter gradient for the parameter values based on the objective function and the at least one constraint comprises: (1) performing, using the analog processor, at least one matrix operation to obtain at least one output of the at least one matrix operation; and (2) determining the parameter gradient using the at least one output of the at least one matrix operation. In some embodiments, performing, using the analog processor, the at least one matrix operation comprises: (1) determining a scaling factor for a portion of a matrix involved in the at least one matrix operation; (2) scaling the portion of the matrix using the scaling factor to obtain a scaled portion of the matrix; (3) programming the analog processor using the scaled portion of the matrix; and (4) performing, by the analog processor programmed using the scaled the portion of the matrix, the at least one matrix operation to obtain the at least one output of the at least one matrix operation.

In some embodiments, the at least one constraint comprises at least one constraint function and the techniques comprise: generating a combined function using the objective function and the at least one constraint function. Determining, using the analog processor, the parameter gradient for the parameter values based on the objective function and the at least one constraint comprises: determining a gradient of the combined function for the parameter values. In some embodiments, determining, using the analog processor, the parameter gradient for the parameter values based on the objective function and the at least one constraint comprises: (1) determining a gradient of the objective function for the parameter values; (2) determining a gradient of the at least one constraint function for the parameter values; and (3) determining the parameter gradient using the gradient of the objective function and the gradient of the at least one constraint function. In some embodiments, determining the parameter gradient using the gradient of the objective function and the gradient of the at least one constraint function comprises: (1) determining a normalization of the gradient of the objective function; (2) determining a normalization of the gradient of the at least one constraint function; and (3) determining the parameter gradient using normalizations of the gradient of the objective function and the gradient of the at least one constraint function.

In some embodiments, the at least one constraint comprises a plurality of constraints (e.g., inequality constraints) represented by a plurality of constraint functions. Determining, using the analog processor, the parameter gradient for the parameter values comprises: (1) generating a barrier function (e.g., a logarithmic barrier function) using the plurality of constraint functions; (2) determining a gradient of the objective function for the parameter values; (3) determining a gradient of the barrier function for the parameter values; and (4) determining the parameter gradient using the gradient of the objective function and the gradient of the barrier function.

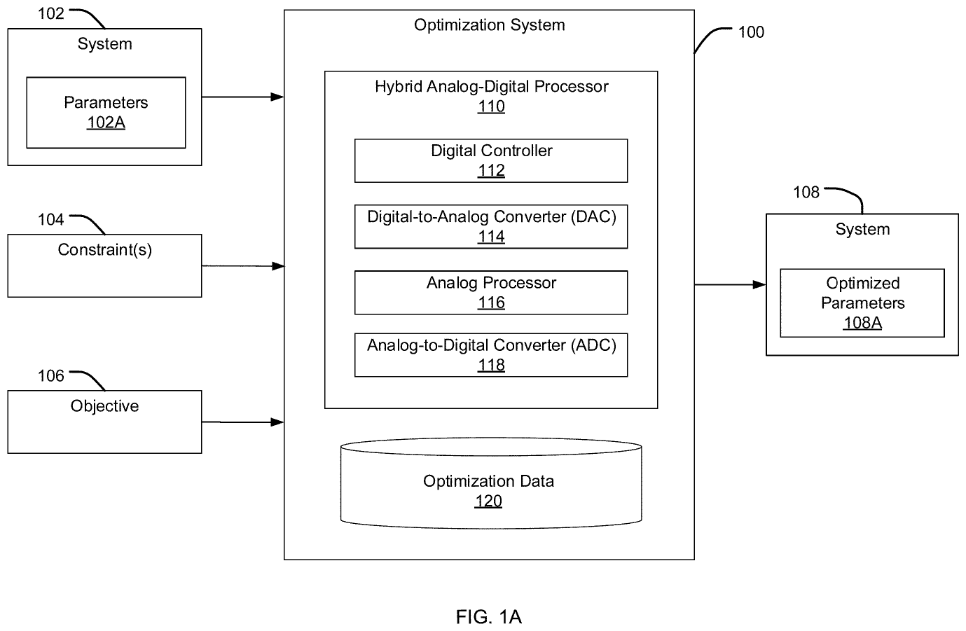

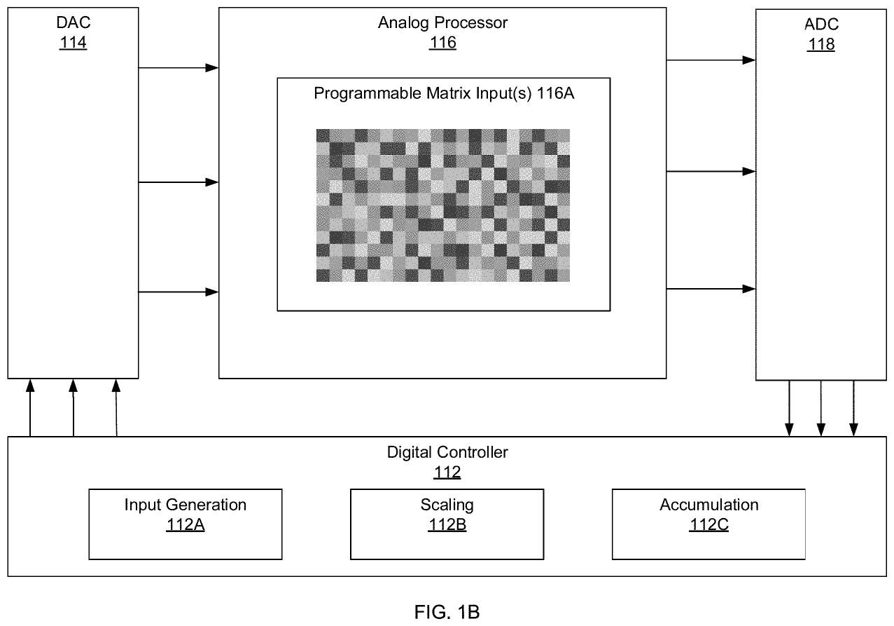

FIG. 1A is an example optimization system 100 configured to perform constrained optimization, according to some embodiments of the technology described herein. As shown in FIG. 1A, the optimization system 100 optimizes a system 102 under one or more constraints 104 for an objective 106 to obtain a system 108 with optimized parameters 108A.

The system 102 includes parameters 102A that are to be configured by the optimization system 100. For example, the system 102 may be a multiple input multiple output (MIMO) system configured to process 5G network communication signals. Parameters of the MIMO system may need to be optimized for processing of 5G network communication signals. As another example, the system 102 may be an electronic financial trading system, in which parameters (e.g., one or more trades) are to be optimized under various constraints (e.g., maximum trade amount, account balance, and/or other constraints) to maximize a return on investment. As another example, the system 102 may be a navigation system in which a route between two locations needs to be optimized under various constraints (e.g., traffic, delivery time, ride-shares, and/or other constraints). As another example, the system 102 may be a scheduling system in which a set of events are to be optimally scheduled under various constraints. As another example, the system 102 may be a jet engine thrust control system in which the thrust generated by the engine is to be optimized under various constraints (e.g., engine operational limits, altitude based limits, and/or climate conditions). As another example, the system 102 may be a fuel injection control system for a vehicle in which fuel injection is to be optimized under various constraints (e.g., fuel efficiency targets, environmental limits, and/or other constraints). As another example, the system 102 may be a machine learning system (e.g., a neural network) and the parameters (e.g., weights) of the machine learning system may need to be optimized under various constraints to maximize performance of the machine learning system in performing a task (e.g., identifying objects in images, categorizing text, predicting presence of a pathogen in a subject, or other task).

In some embodiments, the system 102 may be optimized by the optimization system 100 during operation of the system 102. In some embodiments, the optimization system 100 may be a component of the system 102. For example, the optimization system 100 may be an in situ optimization system (e.g., embedded in the system 102). The system 102 may be configured to use the optimization system 100 to optimize the parameters 102A under the constraint(s) 104. In some embodiments, the system 102 may be optimized by the optimization system 100 in real time. For example, the system 102 may request optimization of the parameters 102A by the optimization system 100 as part of performing a task (e.g., identifying a financial trade, determining an actuation output of a control system, classifying an input sample, identifying an optimal route.

In some embodiments, the system 102 may be optimized by the optimization system 100 before operation. For example, the parameters 102A of the system 102 may be optimized by the optimization system 100 prior to embedding the system 102 in a device. As another example, the parameters 102A of the system 102 may be optimized by the optimization system 100 prior to deployment of the system 102 in a field. As another example, the parameters 102A of the system 102 may be optimized by the optimization system 100 prior to performing a task.

The system 102 may be optimized under one or more constraints 104. A constraint on the system 102 may be stated as one or more mathematical expressions that represent limit(s) placed on the system 102 by the constraint. In some embodiments, a constraint may be indicated as an equality. For example, an equality may indicate a minimum or maximum of a parameter of the system 102. In some embodiments, a constraint may be represented as a function (also referred to herein as a “constraint function”). In some embodiments, a constraint function may represent an inequality constraint on the system 102. In some embodiments, an inequality restraint may be represented as a nonlinear function. For example, the function may be c(x)=∞ if x>d, and zero otherwise.

Inequality constraints may arise in various different optimization problems. For example, an inequality constraint may arise in problems within the convex optimization framework, for example semi-definite programming (SDP) or geometric programing. SDP may be useful when solving a constrained optimization problem for quantum-computing related problems because the quantum density matrix is positive semidefinite. The problem may involve solving for a quantum density matrix given observations or measurements that have been previously performed, and the positive definiteness of the density matrix is presented as a constraint. As another example, the problem of minimum energy processor speed scheduling has an objective of adjusting the processor speeds to solve a compute problem within a certain period of time, but may require that processor(s) stay within an energy budget. An inequality constraint in this context may be defined by a constraint being required to complete a workload within a specific time period (e.g., the processor(s) at or prior to the end of the specific time period). As another example, a maximum thrust may need to be generated while maintaining engine temperature under a certain limit. As another example, a trade that would generate the maximum expected revenue may need to be determined constrained by a maximum trade amount.

The parameters 102A of the system 102 may be optimized by the optimization system 100 for an objective 106. In some embodiments, the objective 106 may be associated with an objective function for evaluating performance of the system 102 for the objective 106. In some embodiments, the optimization system 100 may be configured to optimize the parameters 102A by determining values of the parameters 102A corresponding to a minimum or maximum of the objective function (e.g., a local minimum or local maximum). For example, the objective function may be a loss or cost function that is to be minimized to optimize the system 102. As another example, the objective function may be a reward or utility function that is to be maximized to optimize the system 102.

In some embodiments, an objective function may indicate performance of the system 102 configured with a given set of values for the parameters 102A. The objective function may relate sets of values of the parameters 102A to respective values providing a measure of performance of the system 102 when configured with the sets of values. For example, the objective function may indicate an expected financial trade value, a predicted time for a navigation route, a thrust generated by a jet engine, or other measure of performance of the system 102. In some embodiments, an objective function may be evaluated using a set of test data. The test data may include target outputs of the system 102 for various inputs. The outputs of the system 102 when configured with a set of values of the parameters 102A may be compared to the target outputs to determine performance of the system 102. The objective function may indicate a measure of performance of the system 102 based on a comparison between the target outputs and the outputs of the system 102 configured with the set of values. For example, the objective function may be a loss function for which an output is based on the difference between the target outputs and the outputs of the system 102.

The optimization system 100 may be configured to use the hybrid analog-digital processor 110 to optimize the parameters 102A of the system 102 for the objective 106 under the constraint(s) 104. The optimization system 100 may be configured to use the analog processor 116 of the hybrid analog-digital processor 110 to perform operations involved in optimization of the system 102 under the constraint(s) 104. More specifically, the optimization system 100 may perform the optimization by performing a gradient descent algorithm, where the analog processor 116 is used to perform operations (e.g., matrix operations) involved in performing the gradient descent algorithm.

In some embodiments, the optimization system 100 may be configured to optimize the parameters 102A of the system 102 using: (1) an objective function associated with the objective 106; and (2) one or more constraint functions associated with the constraint(s) 104. The optimization system 100 may be configured to optimize the parameters 102A by performing gradient descent using the hybrid analog-digital processor 110. The hybrid analog-digital processor 110 may be configured to: (1) determine a gradient with respect to the parameters 102A (also referred to as “parameter gradient”); and (2) update the parameters 102A based on the parameter gradient (e.g., descending the parameters 102A by a proportion of the gradient). The hybrid analog-digital processor 110 may be configured to perform the gradient descent using the ABFP number representation. Example techniques of performing gradient descent using the ABFP representation are described herein.

In some embodiments, the optimization system 100 may be configured to generate a combined objective function based on an objective function associated with the objective 106 and one or more constraint functions representing the constraint(s) 104. The combined objective function may comprise of a first component corresponding to the objective 106 and one or more components corresponding to the constraints 104. For example, the first component representing the objective 106 may be an objective function associated with the objective 106, and the component(s) corresponding to the constraint(s) 104 may be the constraint function(s). In some embodiments, the objective function may comprise of a weighted sum of the components.

In some embodiments, the optimization system 100 may be configured to determine: (1) a gradient for an objective function associated with the objective 106; and (2) a gradient for one or more constraint functions. The optimization system 100 may update the parameters 102A of the system 102 using both of the determined gradients. For example, the optimization system 100 may determine a weighted sum of the gradients of the objective function and the constraint function(s) as a parameter gradient. The parameter gradient may then be used to update (e.g., descent) the parameters 102A. In some embodiments, the optimization system 100 may be configured to normalize the gradients of the objective function and the constraint function(s).

The constraint function(s) may comprise multiple constraint functions. The optimization system 100 may be configured to combine the multiple constraint functions. The optimization system 100 may be configured to determine a gradient of the combined constraint functions for use in updating the parameters 102A (e.g., as part of a gradient descent technique). In some embodiments, the optimization system 100 may be configured to combine the constraint functions by generating a new function using the constraint functions. For example, the optimization system 100 may generate barrier function (e.g., a logarithmic barrier function) using the constraint functions. The optimization system 100 may be configured determine a gradient of the barrier function, and use the gradient to update the parameters 102A. The optimization system 100 may be configured to update the parameters 102A of the system 102 using both the gradient of the generated function (e.g., a barrier function) and the gradient of an objective function associated with the objective 106. For example, the optimization system 100 may determine a weighted sum of the gradients as a parameter gradient. In some embodiments, the optimization system 100 may be configured to normalize the gradients of the objective function and the constraint function(s). For example, the optimization system 100 may normalize each gradient by its Euclidean norm, maximum norm, or other suitable normalization function.

Returning again to FIG. 1A, the optimization system 100 includes a hybrid analog-digital processor 110 and a datastore 120 storing optimization data. In some embodiments, the optimization system 100 may include a host central processing unit (CPU). In some embodiments, the optimization system 100 may include a dynamic random-access memory (DRAM) unit. In some embodiments, the host CPU may be configured to communicate with the hybrid analog-digital processor 110 using a communication protocol. For example, the host CPU may communicate with the hybrid analog-digital processor 110 using peripheral component interconnect express (PCI-e), joint test action group (JTAG), universal seral bus (USB), and/or another suitable protocol. In some embodiments, the hybrid analog-digital processor 110 may include a DRAM controller that allows the hybrid analog-digital processor 110 direct memory access from the DRAM unit to memory of the hybrid analog-digital processor 110. For example, the hybrid analog-digital processor 110 may include a double data rate (DDR) unit or a high-bandwidth memory unit for access to the DRAM unit. In some embodiments, the host CPU may be configured to broker DRAM memory access between the hybrid analog-digital processor 110 and the DRAM unit.

The hybrid analog-digital processor 110 includes a digital controller 112, a digital-to-analog converter (DAC) 114, an analog processor 116, and an analog-to-digital converter (ADC) 118.

The components 112, 114, 116, 118 of the hybrid analog-digital processor 110 and optionally other components, may be collectively referred to as “circuitry”. In some embodiments, the components 112, 114, 116, 118 may be formed on a common chip. In some embodiments, the components 112, 114, 116, 118 may be on different chips bonded together. In some embodiments, the components 112, 114, 116, 118 may be connected together via electrical bonds (e.g., wire bonds or flip-chip bump bonds). In some embodiments, the components 112, 114, 116, 118 may be implemented with chips in the same technology node. In some embodiments, the components 112, 114, 116, 118 may be implemented with chips in different technology nodes.

The digital controller 112 may be configured to control operation of the hybrid analog-digital processor 110. The digital controller 112 may comprise a digital processor and memory. The memory may be configured to store software instructions that can be executed by the digital processor. The digital controller 112 may be configured to perform various operations by executing software instructions stored in the memory. In some embodiments, the digital controller 112 may be configured to perform operations involved in optimizing the system 102. Example operations of the digital controller 112 are described herein with reference to FIG. 1B.

The DAC 114 is a system that converts a digital signal into an analog signal. The DAC 114 may be used by the hybrid analog-digital processor 110 to convert digital signals into analog signals for use by the analog processor 116. The DAC 114 may be any suitable type of DAC. In some embodiments, the DAC 114 may be a resistive ladder DAC, switched-capacitor DAC, switched resister DAC, binary-weighted DAC, a thermometer-coded DAC, a successive approximation DAC, an oversampling DAC, an interpolating DAC, and/or a hybrid DAC. In some embodiments, the digital controller 112 may be configured to use the DAC 104 to program the analog processor 116. The digital controller 112 may provide digital signals as input to the DAC 114 to obtain a corresponding analog signal, and configure analog components of the analog processor 116 using the analog signal.

The analog processor 116 includes various analog components. The analog components may include an analog mixer that mixes an input analog signal with an analog signal encoded into the analog processor 116. The analog components may include amplitude modulator(s), current steering circuit(s), amplifier(s), attenuator(s), and/or other analog components. In some embodiments, the analog processor 116 may include metal-oxide-semiconductor (CMOS) components, radio frequency (RF) components, microwave components, and/or other types of analog components. In some embodiments, the analog processor 116 may comprise a photonic processor. Example photonic processors are described herein. In some embodiments, the analog processor 116 may include a combination of photonic and analog electronic components.

The analog processor 116 may be configured to perform one or more matrix operations. The matrix operation(s) may include a matrix multiplication. The analog components may include analog components designed to perform a matrix multiplication. In some embodiments, the analog processor 116 may be configured to perform matrix operations for optimizing the system 102. For example, the analog processor 116 may perform matrix operations for performing forward pass and backpropagation operations involved in performing gradient descent. In this example, the analog processor 116 may perform matrix operations to determine outputs of the system 102 and/or to compute a parameter gradient using outputs of the system 102 (e.g., based on an objective function and the constraint(s) 104).

The ADC 118 is a system that converts an analog signal into a digital signal. The ADC 118 may be used by the hybrid analog-digital processor 110 to convert analog signals output by the analog processor 116 into digital signals. The ADC 118 may be any suitable type of ADC. In some embodiments, the ADC 118 may be a parallel comparator ADC, a flash ADC, a successive-approximation ADC, a Wilkinson ADC, an integrating ADC, a sigma-delta ADC, a pipelined ADC, a cyclic ADC, a time-interleaved ADC, or other suitable ADC.

The datastore 120 may be storage hardware for use by the optimization system 100 in storing information. In some embodiments, the datastore 120 may include a hard drive (e.g., a solid state hard drive and/or a hard disk drive). In some embodiments, at least a portion of the datastore 120 may be external to the optimization system 100. For example, the at least the portion of the datastore 120 may be storage hardware of a remote database server from which the optimization system 100 may obtain data. The optimization system 100 may be configured to access information from the remote storage hardware through a communication network (e.g., the Internet, a local area connection (LAN), or other suitable communication network). In some embodiments, the datastore 120 may include cloud-based storage resources.

As shown in FIG. 1A, the datastore 120 stores optimization data. The optimization data may include sample inputs and/or sample outputs for use in optimizing the system 102. In some embodiments, the sample outputs may be target outputs corresponding to the sample inputs. The sample inputs and target outputs may be used by the optimization system 100 in performing gradient descent to optimize the parameters 102A of the system 102. In some embodiments, the optimization data 120 may include values of the parameters 102A obtained from a previous optimization of the system 102.

The hybrid analog-digital processor 110 may be used by the optimization system 100 in optimizing the parameters 102A of the system 102 to perform a gradient descent algorithm. Performing gradient descent may involve iteratively updating values of the parameters 102A of the system 102 by: (1) determining a parameter gradient based on the objective 106 (e.g., an objective function associated with the objective 106) and the constraint(s) 106; and (2) updating the values of the parameters 102A using the parameter gradient. The hybrid analog-digital processor 110 may be configured to iterate multiple times to optimize the system 102. In some embodiments, the hybrid analog-digital processor 110 may be configured to iterate until a threshold value of an objective function is achieved. In some embodiments, the hybrid analog-digital processor 110 may be configured to iterate until a threshold number of iterations has been performed. Example techniques of determining a parameter gradient are described herein.

The hybrid analog-digital processor 110 may be configured to employ its analog processor 116 in determining a parameter gradient. In some embodiments, the hybrid analog-digital processor 110 may be configured to employ the analog processor 116 to perform one or more matrix operations to determine the parameter gradient. For example, the hybrid analog-digital processor 110 may determine outputs of the system 102 for a set of inputs by performing matrix operation(s) using the analog processor 116. As another example, the hybrid analog-digital processor 110 may further perform matrix operation(s) for determining a parameter gradient from the outputs of the system 102. Use of the analog processor 106 to perform the matrix operations may accelerate optimization and require less power to perform relative to optimization performed without an analog processor.

To perform a matrix operation using the analog processor 116, the digital controller 112 may program the analog processor 116 with matrices involved in a matrix operation. The digital controller 112 may program the analog processor 106 using the DAC 104. Programming the analog processor 106 may involve setting certain characteristics of the analog processor 116 according to the matrices involved in the matrix operation. In one example, the analog processor 116 may include multiple electronic amplifiers (e.g., voltage amplifiers, current amplifiers, power amplifiers, transimpedance amplifiers, transconductance amplifiers, operational amplifiers, transistor amplifiers, and/or other amplifiers). In this example, programming the analog processor 116 may involve setting gains of the electronic amplifiers based on the matrices. In another example, the analog processor 116 may include multiple electronic attenuators (e.g., voltage attenuators, current attenuators, power attenuators, and/or other attenuators). In this example, programming the analog processor 116 may involve setting the attenuations of the electronic attenuators based on the matrices. In another example, the analog processor 116 may include multiple electronic phase shifters. In this example, programming the analog processor 106 may involve setting the phase shifts of the electronic phase shifters based on the matrices. In another example, the analog processor 116 may include an array of memory devices (e.g., flash or ReRAM). In this example, programming the analog processor 106 may involve setting conductances and/or resistances of each of the memory cells. The analog processor 116 may perform the matrix operation to obtain an output. The digital controller 112 may obtain a digital version of the output through the ADC 118.

The hybrid analog-digital processor 110 may be configured to use the analog processor 116 to perform matrix operations by using an ABFP representation for matrices involved in an operation. The hybrid analog-digital processor 110 may be configured to determine, for each matrix involved in an operation, scaling factor(s) for one or more portions of the matrix (“matrix portion(s)”). In some embodiments, a matrix portion may be the entire matrix. In some embodiments, a matrix portion may be a submatrix within the matrix. The hybrid analog-digital processor 110 may be configured to scale a matrix portion using its scaling factor to obtain a scaled matrix portion. For example, values of the scaled matrix portion may be normalized within a range (e.g., [−1, 1]). The hybrid analog-digital processor 110 may program the analog processor 116 using the scaled matrix portion.

In some embodiments, the hybrid analog-digital processor 110 may be configured to program the analog processor 116 using the scaled matrix portion by programming the scaled matrix portion into a fixed-point representation used by the analog processor 116. In some embodiments, the fixed-point representation may be asymmetric around zero, with a 1-to-1 correspondence to integer values from

$$- {2}^{\frac{B}{2}} to {2}^{\frac{B}{2}} - 1 ,$$

where B is the bit precision. In some embodiments, the representations may be symmetric around zero, with a 1-to-1 correspondence to integer bit values from

$$- {2}^{\frac{B}{2}} - 1 to {2}^{\frac{B}{2}} - 1 .$$

The analog processor 116 may be configured to perform the matrix operation using the scaled matrix portion to generate an output. The hybrid analog-digital processor 110 may be configured to determine an output scaling factor for the output generated by the analog processor 116. In some embodiments, the hybrid analog-digital processor 110 may be configured to determine the output scaling factor based on the scaling factor determined for the corresponding input. For example, the hybrid analog-digital processor 110 may determine the output scaling factor to be an inverse of the input scaling factor. The hybrid analog-digital processor 110 may be configured to scale the output using the output scaling factor to obtain a scaled output. The hybrid analog-digital processor 110 may be configured to determine a result of the matrix operation using the scaled output.

FIG. 1B illustrates interaction among components 112, 114, 116, 118 of the hybrid analog-digital processor 100 of FIG. 1A, according to some embodiments of the technology described herein.

As shown in FIG. 1B, the digital controller 112 includes an input generation component 112A, a scaling component 112B, and an accumulation component 112C.

The input generation component 112A may be configured to generate inputs to a matrix operation to be performed by the hybrid analog-digital processor 110. In some embodiments, the input generation component 112A may be configured to generate inputs to a matrix operation by determining one or more matrices involved in the matrix operation. For example, the input generation component 101A may determine two matrices to be multiplied in a matrix multiplication operation.

In some embodiments, the input generation component 112A may be configured to divide matrices involved in a matrix operation into multiple portions such that the result of a matrix operation may be obtained by performing multiple operations using the multiple portions. In such embodiments, the input generation component 112A may be configured to generate input to a matrix operation by extracting a portion of a matrix for an operation. For example, the input generation component 112A may extract a vector (e.g., a row, column, or portion thereof) from a matrix. In another example, the input generation component 112A may extract a portion of an input vector for a matrix operation. To illustrate, the input generation component 112A may obtain a matrix of input values (also referred to as “input vector”), and a matrix of parameters of the system 102. A matrix multiplication may need to be performed between the input matrix and the weight matrix. In this example, the input generation component 112A may: (1) divide the parameter matrix into multiple smaller parameter matrices; and (2) divide the input vector into multiple vectors corresponding to the multiple parameter matrices. The matrix operation between the input vector and the parameter matrix may then be performed by: (1) performing the matrix operation between each of the multiple parameter matrices and the corresponding vectors; and (2) accumulating the outputs.

In some embodiments, the input generation component 112A may be configured to obtain one or more matrices from a tensor for use in performing matrix operations. For example, the input generation component 112A may divide a tensor of input values and/or a tensor of parameter values. The input generation component 112A may be configured to perform reshaping or data copying to obtain the matrices. For example, for a convolution operation between a weight kernel tensor and an input tensor, the input generation component 112A may generate a matrix using the weight kernel tensor, in which column values of the matrix correspond to a kernel of a particular output channel. The input generation component 112A may generate a matrix using the input tensor, in which each row of the matrix includes values from the input tensor that will be multiplied and summed with the kernel of a particular output channel stored in columns of the matrix generated using the weight kernel tensor. A matrix operation may then be performed between the matrices obtained from weight kernel tensor and the input tensor.

The scaling component 112B of the digital controller 112 may be configured to scale matrices (e.g., vectors) involved in a matrix operation. The matrices may be provided by the input generation component 112A. For example, the scaling component 112B may scale a matrix or portion thereof provided by the input generation component 112A. In some embodiments, the scaling component 112B may be configured to scale each portion of a matrix. For example, the scaling component 112B may separately scale vectors (e.g., row vectors or column vectors) of the matrix. The scaling component 112B may be configured to scale a portion of a matrix by: (1) determining a scaling factor for the portion of the matrix; and (2) scaling the portion of the matrix using the scaling factor to obtain a scaled portion of the matrix. For example, the scaling component 112B may be configured to scale a portion of a matrix by dividing values in the portion of the matrix by the scaling factor. As another example, the scaling component 112B may be configured to scale a portion of a matrix by multiplying values in the portion of the matrix by the scaling factor.

The scaling component 112B may be configured to determine a scaling factor for a portion of a matrix using various techniques. In some embodiments, the scaling component 112B may be configured to determine a scaling factor for a portion of a matrix to be a maximum absolute value of the portion of the matrix. The scaling component 112B may then divide each value in the portion of the matrix by the maximum absolute value to obtain scaled values in the range [−1, 1]. In some embodiments, the scaling component 112B may be configured to determine a scaling factor for a portion of a matrix to be a norm of the portion of the matrix. For example, the scaling component 112B may determine a Euclidean norm of a vector.

In some embodiments, the scaling component 112B may be configured to determine a scaling factor as a whole power of 2. For example, the scaling component 112B may determine a logarithmic value of a maximum absolute value of the portion of the matrix to be the scaling factor. In such embodiments, the scaling component 112B may further be configured to round, ceil, or floor a logarithmic value to obtain the scaling factor. In some embodiments, the scaling component 112B may be configured to determine the scaling factor statistically. In such embodiments, the scaling component 112B may pass sample inputs through the system 102, collect statistics on the outputs, and determine the scaling factor based on the statistics. For example, the scaling component 112B may determine a maximum output of the system 102 based on the outputs, and use the maximum output as the scaling factor. In some embodiments, the scaling component 112B may be configured to determine a scaling factor by performing a machine learning training technique (e.g., backpropagation or stochastic gradient descent). The scaling component 112B may be configured to store scaling factors determined for portions of matrices. For example, the scaling component 112B may store scaling factors determined for respective rows of weight matrices of a neural network.

The scaling component 112B may be configured to limit scaled values of a scaled portion of a matrix to be within a desired range. For example, the scaling component 112B may limit scaled values of a scaled portion of a matrix to between [−1, 1]. In some embodiments, the scaling component 112B may be configured to limit scaled values to a desired range by clamping or clipping. For example, the scaling component 112B may apply the following clamping function to the scaled values: clamp(x)=min(max(x, −1), 1) to set the scaled values between [−1, 1]. In some embodiments, the scaling component 112B may be configured to determine scaling factor for a portion of a matrix that is less than the maximum absolute value of the portion of the matrix. In some such embodiments, the scaling component 112B may be configured to saturate scaled values. For example, the scaling component 112B may saturate a scaled value at a maximum of 1 and a minimum of −1.

The scaling component 112B may be configured to determine a scaling factor at different times. In some embodiments, the scaling component 112B may be configured to determine a scaling factor dynamically at runtime when a matrix is being loaded onto the analog processor. For example, the scaling component 112B may determine a scaling factor for an input vector for a neural network at runtime when the input vector is received. In some embodiments, the scaling component 112B may be configured to determine a scaling factor prior to runtime. The scaling component 112B may determine the scaling factor and store it in the datastore 120. For example, weight matrices of a neural network may be static for a period of time after training (e.g., until they are to be retrained or otherwise updated). The scaling component 112B may determine scaling factor(s) to be used for matrix operations involving the matrices, and store the determined scaling factor(s) for use when performing matrix operations involving the weight matrices. In some embodiments, the scaling component 112B may be configured to store scaled matrix portions. For example, the scaling component 112B may store scaled portions of weight matrices of a neural network such that they do not need to be scaled during runtime.

The scaling component 112B may be configured to amplify or attenuate one or more analog signals for a matrix operation. Amplification may also be referred to herein as “overamplification”. Typically, the number of bits required to represent an output of a matrix operation increases as the size of one or more matrices involved in the matrix operation increases. For example, the number of bits required to represent an output of a matrix multiplication operation increases as the size of the matrices being multiplied increases. The precision of the hybrid analog-digital processor 110 may be limited to a certain number of bits. For example, the ADC 118 of the hybrid analog-digital processor may have a bit precision limited to a certain number of bits (e.g., 4, 6, 8, 10, 12, 14). As the number of bits required to represent an output of a matrix operation increases more information is lost from the output of the matrix operation because a fewer number of significant bits can be captured by the number of bits. The scaling component 112B may be configured to increase a gain of an analog signal such that a larger number of lower significant bits may be captured in an output, at the expense of losing information in more significant bits. This effectively increases the precision of an output of the matrix operation because the lower significant bits may carry more information for training the machine learning model 112 than the higher significant bits.

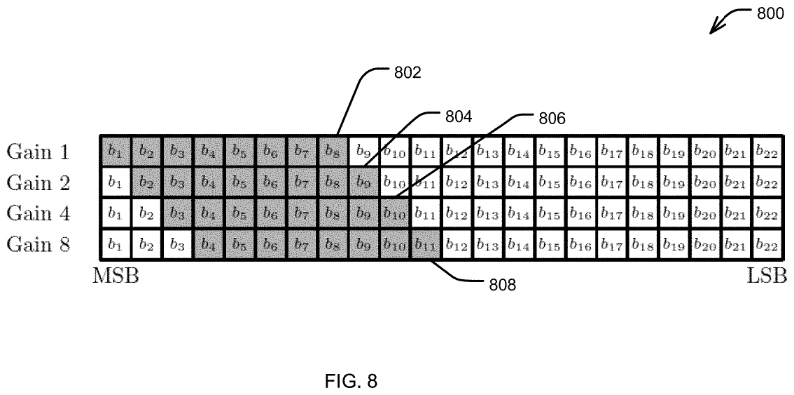

FIG. 8 is a diagram illustrating effects of overamplification, according to some embodiments of the technology described herein. The diagram 800 illustrates the bits of values that would be captured for different levels of overamplification. In the example of FIG. 8, there is a constant precision of 8 bits available to represent a 22 bit output. When no amplification is performed (“Gain 1”), the output captures the 8 most significant bits b₁-b₈ of the output as indicated by the set of highlighted blocks 802. When the analog signal is amplified by a factor of 2 (“Gain 2”), the output captures the bits b₂-b₉ of the output as indicated by the set of highlighted blocks 804. When the analog signal is amplified by a factor of 4 (“Gain 4”), the output captures the bits b₃-b₁₀ of the output as indicated by the set of highlighted blocks 806. When the analog signal is amplified by a factor of 8 (“Gain 8”), the output captures the bits b₄-b₁₁ of the output as indicated by the set of highlighted blocks 808. As can be understood from FIG. 8, increasing the gain allows the output to capture additional lower significant bits at the expense of higher significant bits.

Returning again to FIG. 1B, the accumulation component 112C may be configured to determine an output of a matrix operation between two matrices by accumulating outputs of multiple matrix operations performed using the analog processor 116. In some embodiments, the accumulation component 112C may be configured to accumulate outputs by compiling multiple vectors in an output matrix. For example, the accumulation component 112C may store output vectors obtained from the analog processor (e.g., through the ADC 118) in columns or rows of an output matrix. To illustrate, the hybrid analog-digital processor 110 may use the analog processor 116 to perform a matrix multiplication between a parameter matrix and an input matrix to obtain an output matrix. In this example, the accumulation component 112C may store the output vectors in an output matrix. In some embodiments, the accumulation component 112C may be configured to accumulate outputs by summing the output matrix with an accumulation matrix. The final output of a matrix operation may be obtained after all the output matrices have been accumulated by the accumulation component 112C.

In some embodiments, the hybrid analog-digital processor 110 may be configured to determine an output of a matrix operation using tiling. Tiling may divide a matrix operation into multiple operations between smaller matrices. Tiling may allow reduction in size of the hybrid analog-digital processor 110 by reducing the size of the analog processor 116. As an illustrative example, the hybrid analog-digital processor 110 may use tiling to divide a matrix multiplication between two matrices into multiple multiplications between portions of each matrix. The hybrid analog-digital processor 110 may be configured to perform the multiple operations in multiple passes. In such embodiments, the accumulation component 112C may be configured to combine results obtained from operations performed using tiling into an output matrix.

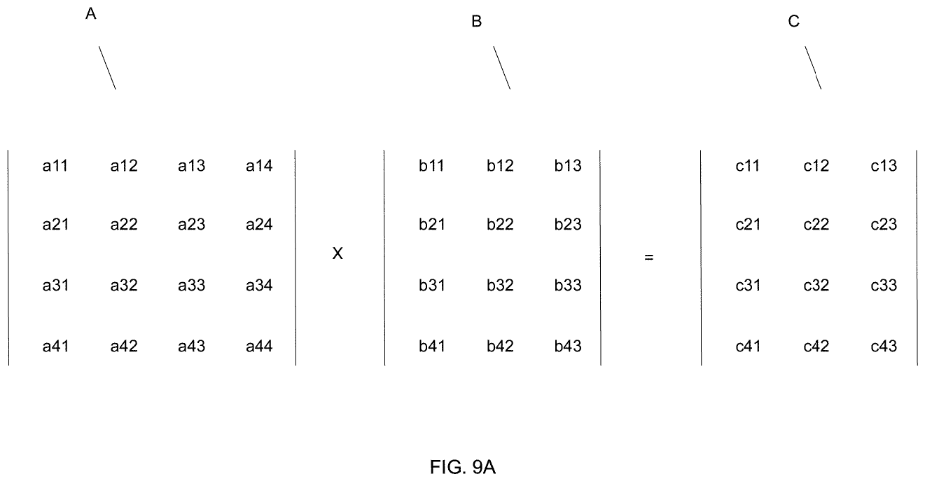

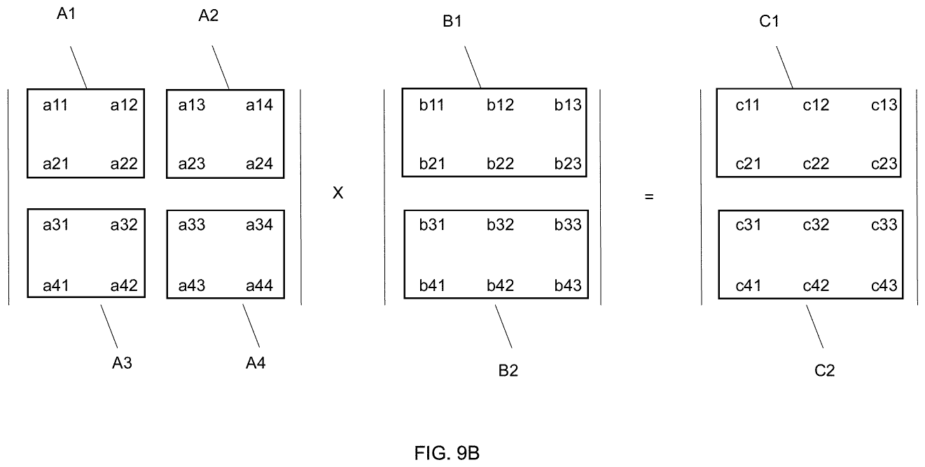

FIG. 9A is an example matrix multiplication operation, according to some embodiments of the technology described herein. For example, the matrix multiplication may be performed as part of optimizing the parameters 102A of the system 102 under the constraint(s) 104. In the example of FIG. 9A, the matrix A may store the weights of a layer, and the matrix B may be an input matrix provided to the layer. The system may perform matrix multiplication between matrix A and matrix B to obtain output matrix C.

FIG. 9B illustrates use of tiling to perform the matrix multiplication operation of FIG. 9A, according to some embodiments of the technology described herein. In FIG. 9B, the hybrid analog-digital processor 110 divides the matrix A into four tiles—A1, A2, A3, and A4. In this example, each tile of A has two rows and two columns (though other numbers of rows and columns are also possible). The hybrid analog-digital processor 110 divides the matrix B into tile rows B1 and B2, and matrix C is segmented into rows C1 and C2. The row C1 and C2 are given by the following expressions:

C1=A1*B1+A2*B2 Equation (1)

C2=A3*B1+A4*B2 Equation (2)

In equation 1 above, the hybrid analog-digital processor 110 may perform the multiplication of A1*B1 separately from the multiplication of A2*B2. The accumulation component 112C may subsequently accumulate the results to obtain C1. Similarly, in equation 2, the hybrid analog-digital processor 110 may perform the multiplication of A3*B1 separately from the multiplication of A4*B2. The accumulation component 112C may subsequently accumulate the results to obtain C2.

The DAC 114 may be configured to convert digital signals provided by the digital controller 112 into analog signals for use by the analog processor 116. In some embodiments, the digital controller 112 may be configured to use the DAC 114 to program a matrix into the programmable matrix input(s) 116A of the analog processor 116. The digital controller 112 may be configured to input the matrix into the DAC 114 to obtain one or more analog signals for the matrix. The analog processor 116 may be configured to perform a matrix operation using the analog signal(s) generated from the matrix input(s) 116A. In some embodiments, the DAC 114 may be configured to program a matrix using a fixed point representation of numbers used by the analog processor 116.

The analog processor 116 may be configured to perform matrix operations on matrices programmed into the matrix input(s) 116A (e.g., through the DAC 114) by the digital controller 112. In some embodiments, the matrix operations may include matrix operations for optimizing parameters 102A of the system 102 using gradient descent. For example, the matrix operations may include forward pass matrix operations to determine outputs of the system 102 for a set of inputs (e.g., for an iteration of a gradient descent technique). The matrix operations further include backpropagation matrix operations to determine one or more gradients. The gradient(s) may be used to update the parameters 102A of the system 102 (e.g., in an iteration of a gradient descent learning technique).

In some embodiments, the analog processor 116 may be configured to perform a matrix operation in multiple passes using matrix portions (e.g., portions of an input matrix and/or a weight matrix) determined by the digital controller 112. The analog processor 116 may be programmed using scaled matrix portions, and perform the matrix operations. For example, the analog processor 116 may be programmed with a scaled portion(s) of an input matrix (e.g., a scaled vector from the input matrix), and scaled portion(s) of a weight matrix (e.g., multiple scaled rows of the weight matrix). The programmed analog processor 116 may perform the matrix operation between the scaled portions of the input matrix and the weight matrix to generate an output. The output may be provided to the ADC 118 to be converted back into a digital floating-point representation (e.g., to be accumulated by accumulation component 112C to generate an output).

In some embodiments, a matrix operation may be repeated multiple times, and the results may be averaged to reduce the amount of noise present within the analog processor. In some embodiments, the matrix operations may be performed between certain bit precisions of the input matrix and the weight matrix. For example, an input matrix can be divided into two input matrices, one for the most significant bits in the fixed-point representation and another for the least significant bits in the fixed-point representation. A weight matrix may also be divided into two weight matrices, the first with the most significant bit portion and the second with the least significant bit portion. Multiplication between the original weight and input matrix may then be performed by performing a multiplications between: (1) the most-significant weight matrix and the most-significant input matrix; (2) the most-significant weight matrix and the least-significant input matrix; (3) the least-significant weight matrix and the most-significant input matrix; and (4) the least-significant weight matrix and the least-significant input matrix. The resulting output matrix can be reconstructed by taking into account the output bit significance.

The ADC 118 may be configured to receive an analog output of the analog processor 116, and convert the analog output into a digital signal. In some embodiments, the ADC 118 may include logical units and circuits that are configured to convert a values from a fixed-point representation to a digital floating-point representation used by the digital controller 112. For example, the logical units and circuits of the ADC 118 may convert a matrix from a fixed point representation of the analog processor 116 to a 16 bit floating-point representation (“float16” or “FP16”), a 32 bit floating-point representation (“float32” or “FP32”), a 64 bit floating-point representation (“float32” or “FP32”), a 16 bit brain floating-point format (“bfloat16”), a 32 bit brain floating-point format (“bfloat32”), or another suitable floating-point representation. In some embodiments, the logical units and circuits may be configured to convert values from a first fixed-point representation to a second fixed-point representation. The first and second fixed-point representations may have different bit widths. In some embodiments, the logical units and circuits may be configured to convert a value into unums (e.g., posits and/or valids).

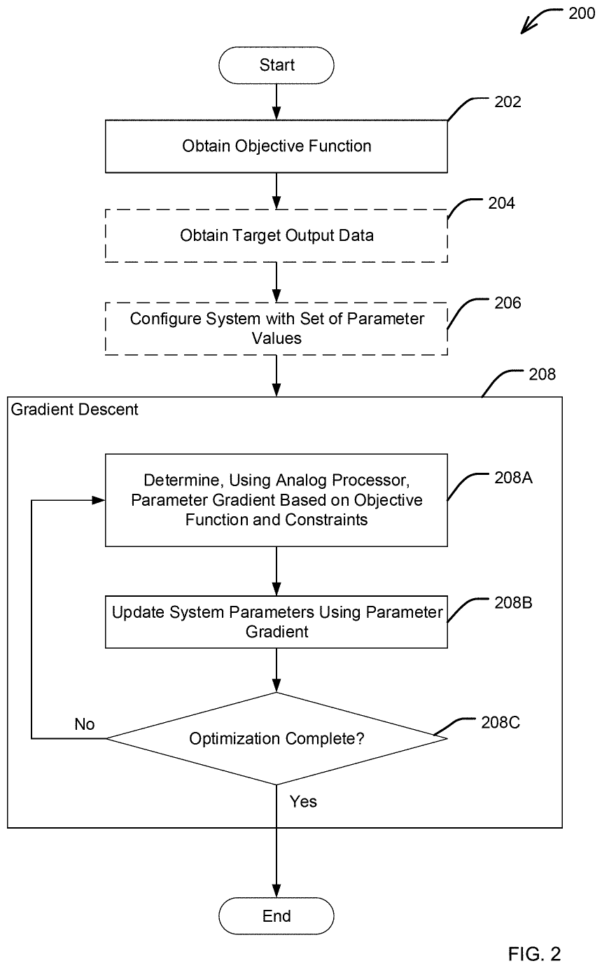

FIG. 2 is a flowchart of an example process 200 of optimizing parameters of a given system for an objective under one or more constraints using a hybrid analog-digital processor, according to some embodiments of the technology described herein. In some embodiments, process 200 may be performed by optimization system 100 to optimize system 102 using hybrid analog-digital processor 110.

Process 200 begins at block 200, where the optimization given system obtains an objective function. The objective function may represent the objective for which a given system is to be optimized. In some embodiments, the objective function may relate sets of parameter values of the given system to values providing a measure of performance of the given system. For example, the objective function may be a loss function that is to be minimized in optimizing (e.g., learning) parameters of a machine learning system (e.g., weights of a neural network). In another example, the objective function may be a reward function that is to be maximized. In some embodiments, the objective function may indicate one or more system outputs (e.g., speed, thrust, monetary value, route time, etc.) that are to be minimized or maximized. Example objective functions are described herein.

Next, process 200 proceeds to block 204, where the optimization system obtains target output data. The target output data may comprise one or more target output values that the given system is to generate for a corresponding set of input value(s). For example, the target output value(s) may be labels associated with sets of input features to be used in learning parameter values of a machine learning system, a control system, a MIMO 5G processing system, or other system. As indicated by the dashed lines of block 204, in some embodiments, the optimization system may perform process 200 without obtaining target output data.

Next, process 200 proceeds to block 206, where the optimization system configures the given system with a set of parameter values. In some embodiments, the optimization system may configure the given system with a random set of parameter values. In some embodiments, the optimization system may configure the given system with a default set of parameter values. In some embodiments, the optimization system may configure the given system with a set of parameter values determined from another optimization performed on the given system. As indicated by the dashed lines of block 206, in some embodiments, the optimization system may not configure the given system with a set of parameter values. For example, the given system may have previously configured with a set of parameter values.

Next, process 200 proceeds to block 208, where the optimization system iteratively performs gradient descent to optimize parameter values of the given system. The block 208 includes the steps at blocks 208A-208C.

At block 208A, the optimization system determines, using an analog processor (e.g., analog processor 116 described herein with reference to FIGS. 1A-1B), a parameter gradient based on the objective function and the constraints. The optimization system may be configured to use the analog processor to determine the parameter gradient by using the analog processor to perform: (1) performing one or more matrix operations involved in determining output(s) of the given system in the analog processor; and/or (2) performing one or more matrix operations involved in determining the parameter gradient based on the determined output(s). For example, the optimization system may determine outputs of the given system by performing one or more matrix multiplications between matrices storing parameters of the given system and matrices of input values. As another example, the optimization system may perform matrix multiplication(s) to determine the parameter gradient using output obtained from the system for a set of inputs. In some embodiments, the optimization system may be configured to use the ABFP representation to perform matrix operations. Example techniques for performing a matrix operation using the ABFP representation are described herein.

In some embodiments, the optimization system may be configured to generate a combined objective function based on an objective function associated with the objective and constraint function(s) associated with the constraint(s). The combined objective function may comprise of a first component representing the objective and one or more components representing the constraint(s). For example, the first component representing the objective may be a first objective function, and the component(s) representing the constraint(s) may be one or more constraint functions. In some embodiments, the objective function may comprise of a weighted sum of the components. Equation 3 below shows an example objective function obtained by combining an objective function associated with the objective and constraint function(s) representing the constraint(s).

L=ƒ(x)+Σᵢkᵢgᵢ(x) Equation (3)

In Equation 3 above, x indicates the parameters of the given system, ƒ(x) is an objective function associated with the objective, gᵢ(x) are constraint functions representing constraints, and kᵢ are weight values associated with respective constraint functions. The optimization system may be configured to determine a parameter gradient to be a gradient of the combined objective function (e.g., the objective function L of Equation 3) with respect to the parameters.

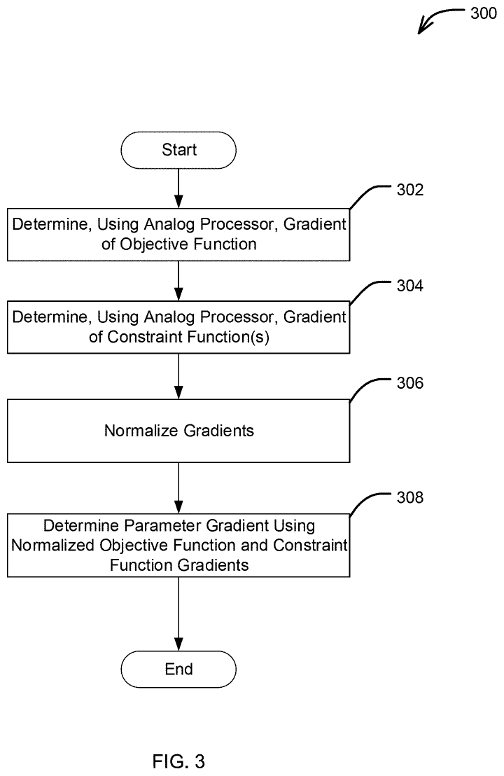

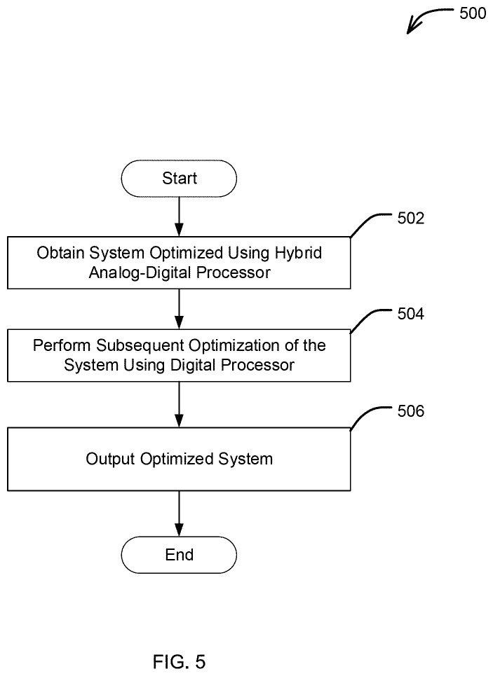

In some embodiments, the optimization system may be configured to determine the parameter gradient by determining: (1) a first gradient for an objective function associated with the objective; and (2) a second gradient for the constraint function(s) associated with the constraint(s) (e.g., as described herein with reference to FIG. 3). In some embodiments, the optimization system may be configured to determine a parameter gradient by generating a function using the constraint(s) (e.g., the constraint function(s)), and determining the parameter gradient using the generated function (e.g., as described herein with reference to FIG. 5).

In some embodiments, the given system may be a machine learning given system. In such embodiments, the optimization system may be configured to determine a parameter gradient by: (1) using parameters of the machine learning given system (e.g., a neural network) to determine outputs of the machine learning given system for a set of inputs; (2) comparing the outputs to target outputs (e.g., labels obtained at block 204); and (3) determining the parameter gradient based on a difference between the outputs and the target outputs. Determining the outputs of the machine learning given system and the parameter gradient based on the difference between the outputs and the target outputs may involve matrix operations (e.g., matrix multiplications) that the optimization system may perform using an analog processor (e.g., analog processor 116). For example, performing inference to determine the outputs of the machine learning given system may involve matrix multiplications. As another example, determining a parameter gradient based on the output values may involve matrix multiplications.

After determining the parameter gradient at block 208A, process 200 proceeds to block 208B, where the optimization system updates the given system parameters using the parameter gradient. This step may also be referred to as a “descent” of the parameters. In some embodiments, the optimization system may be configured to update the given system parameters by adding or subtracting a fraction of the parameter gradient to the parameters. The fraction may also be referred to as a “learning rate” and may be a configurable parameter (e.g., to control a rate at which parameters are updated in each iteration). Equation 4 below captures the update to the parameters of the given system based on the parameter gradient.

x←x−αΔx Equation (4)

In the example of Equation 4 above, the parameters x are updated in each iteration by subtracting α fraction a of the parameter gradient Δx from the current parameter values. In some embodiments, the process of updating the parameters based on the parameter gradient may be performed by a digital controller of a hybrid analog-digital processor. For example, the digital controller may perform the operation of Equation 6 on the parameters of the given system to update the parameters. In some embodiments, the values of Ax can be computed using the ABFP numerical format. In some embodiments the update of x may be performed using digital hardware (e.g., a digital circuit). The update of x, since it is performed in a digital circuit, may be done in a floating-point format, a fixed-point format, or unums.

Next, process 200 proceeds to block 208C, where the optimization system determines whether optimization is complete. In some embodiments, the optimization system may be configured to determine whether the optimization is complete based on whether a threshold number of iterations of the steps in block 208 have been completed. In some embodiments, the optimization system may be configured to determine whether the optimization is complete based on whether the given system has achieved a threshold level of performance. The optimization system may determine whether the given system has achieved a threshold level of performance for the objective under the constraint(s). For example, the optimization system may determine whether an output of an objective function associated with the objective meets a threshold value. As another example, the optimization system may determine one or more performance metrics of the given system configured with the updated parameters. In some embodiments, the optimization system may be configured to determine whether optimization is complete by determining whether an update to the parameters is below a threshold amount. For example, the optimization system may determine optimization is complete if the sum of the absolute values of updates to parameters in an iteration is less than a threshold amount.

If at block 208C the optimization system determines that optimization is complete, then process 200 ends and optimization of the given system is complete. If at block 208C the optimization system determines that optimization is not complete, then process 200 proceeds to block 208A to perform a subsequent iteration of determining a parameter gradient and updating the parameters of the given system. The optimization system may be configured to perform the subsequent iteration on the given system configured with the updated parameter values.

FIG. 3 is a flowchart of an example process 300 of determining a parameter gradient based on an objective function and constraint(s), according to some embodiments of the technology described herein. In some embodiments, process 300 may be performed by optimization system 100 described herein with reference to FIGS. 1A-1B. In some embodiments, process 300 may be performed as part of a process of optimizing parameters of a system for an objective under the constraint(s). For example, process 300 may be performed at block 208A of process 200 described herein with reference to FIG. 2.

Process 300 begins at block 302, where the optimization system performing process 300 determines, using an analog processor (e.g., analog process 116) a gradient of an objective function associated with the objective. The optimization system may be configured to determine the gradient objective function by: (1) determining output of the given system for one or more inputs; and (2) determine a gradient of the objective function with respect to the parameters based on the output of the given system. For example, the given system may determine a gradient of the objective function with respect to the parameters by comparing output values to target output values (e.g., labels).

The optimization system may be configured to use the analog processor to determine the gradient of the objective functions by performing matrix operations (e.g., matrix multiplications) for determining the gradient using the analog processor. Example techniques for performing matrix operations using an analog processor are described herein.

Next, process 300 proceeds to block 304, where the optimization system determines, using the analog processor, a gradient of constraint function(s). In some embodiments, the optimization system may be configured to, for each of the constraint function(s), determine a gradient of the constraint function with respect to the parameters. In some embodiments, the optimization system may be configured to combine the constraint function(s) (e.g., by summing them) into a combined constraint function, and determine a gradient of the combined constraint function. In some embodiments, the optimization system may be configured to generate a function (e.g., a barrier function) using multiple constraint functions and determine a gradient of the generated function with respect to the parameters.

The optimization system may be configured to use the analog processor to determine the gradient of the constraint function(s) by performing matrix operations (e.g., matrix multiplications) for determining the gradient using the analog processor. Example techniques for performing matrix operations using an analog processor are described herein.

Next, process 300 proceeds to block 306, where the optimization system normalizes the gradient of the objective function and the gradient of the constraint function(s). For example, the optimization system may normalize each gradient by its Euclidean norm, maximum norm, or other suitable normalization function. The optimization system may be configured to normalize a gradient by: (1) determining a normalization function of the gradient; and (2) dividing the gradient by its norm.

Next, process 300 proceeds to block 308, where the optimization system determines the parameter gradient using the normalized gradients of the objective function and the constraint function(s). In some embodiments, the optimization system may be configured to sum the normalized gradients. In some embodiments, the optimization system may be configured to determine a weighted sum of the normalized gradients. For example, the optimization system may apply a weight to a gradient of the objective function and/or the gradient of the constraint function(s). In some embodiments, the optimization system may be configured to determine a mean of the gradients, or determine another value using the normalized gradients.

Equation 5 below shows an example gradient that may be determined using normalized gradients of an objective function ƒ(x) and an objective function g(x).

$$Δ x = \frac{∇ f}{\vert ∇ f \vert} + μ \frac{∇ g}{\vert ∇ g \vert} \qquad Equation ( 5 )$$

In Equation 5, Δx is the combined gradient of the parameters of the given system 102, ∇ƒ is the objective function gradient, Vg is a constraint function gradient, |⋅| is a Euclidean norm, and μ is a weight value applied to the normalized constraint function gradient. In some embodiments, the parameter μ may be a value between 0 and 1.

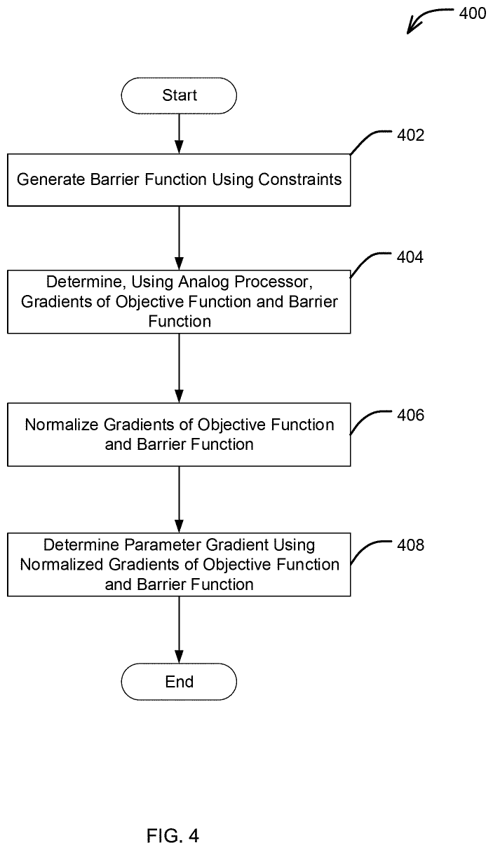

FIG. 4 is a flowchart of another example process 400 of determining a parameter gradient based on an objective function and multiple constraints, according to some embodiments of the technology described herein. In some embodiments, process 400 may be performed by optimization system 100 described herein with reference to FIGS. 1A-1B. In some embodiments, process 400 may be performed as part of a process of optimizing parameters of a system for an objective under the constraint(s). For example, process 400 may be performed at block 208A of process 200 described herein with reference to FIG. 2.

Process 400 begins at block 400, where the optimization system generates a barrier function using constraint functions associated with the multiple constraints. The optimization system may generate a barrier function to generate a continuous function for use in performing gradient descent. For example, the constraint functions may include non-linear inequality constraints. The optimization system may generate a barrier function from the inequality constraints to obtain a continuous function which may be more suitable for performance of gradient descent (e.g., because the continuous function is differentiable). In some embodiments, the optimization system may be configured to generate a logarithmic barrier function using the constraint functions. The optimization system may be configured to generate a logarithmic barrier function by applying a log function to each of the constraint functions and combining the resulting functions. Equation 6 below gives an example of a logarithmic barrier function that may be generated by the optimization system.

$$φ ( x ) = - {\sum }_{i} log ( - {g}_{i} ( x ) ) \qquad Equation ( 6 )$$

In Equation 6 above, φ(x) is a logarithmic barrier function generated by: (1) applying a log function to the negative of each constraint function gᵢ(x); (2) summing the results of applying the log functions; and (3) negating the result of the summation.

Next, process 400 proceeds to block 404, the optimization system determines, using an analog processor, gradients of the objective function and the barrier function. a gradient of an objective function associated with the objective. The optimization system may be configured to determine each gradient by: (1) determining output of the given system for one or more inputs; and (2) determining the gradient with respect to the parameters based on the output of the given system. For example, the given system may determine a gradient of the objective function and/or the barrier function with respect to the parameters by comparing output values to target output values (e.g., labels). In some embodiments, the optimization system may be configured to use the analog processor to determine the gradient of the objective function and the gradient of the barrier function by performing matrix operations (e.g., matrix multiplications) for determining the gradients using the analog processor.

Next, process 400 proceeds to block 406, where the optimization system normalizes the gradient of the objective function and the gradient of the barrier function. For example, the optimization system may normalize each gradient by its Euclidean norm, maximum norm, or other suitable normalization function. The optimization system may be configured to normalize a gradient by: (1) applying a normalization function to the gradient; and (2) dividing the gradient by a result of applying the normalization function to the gradient.

Next, process 400 proceeds to block 408, where the optimization system determines the parameter gradient using the normalized gradients of the objective function and the constraint function(s). In some embodiments, the optimization system may be configured to sum the normalized gradients. In some embodiments, the optimization system may be configured to determine a weighted sum of the normalized gradients. For example, the optimization system may apply a weight to a gradient of the objective function and/or the gradient of the constraint function(s). In some embodiments, the optimization system may be configured to determine a mean of the gradients, or determine another value using the normalized gradients. Equation 7 below shows an example gradient that may be determined by combining gradients of an objective function ƒ(x) and the barrier function φ(x) of Equation 3.

$$Δ x = \frac{∇ f}{\vert f \vert} + μ \frac{∇ φ}{\vert ∇ φ \vert} \qquad Equation ( 7 )$$

In Equation 7, Δx is the combined gradient of the parameters of the given system, ∇ƒ is the objective function gradient, ∇φ is barrier function gradient, |⋅| is a Euclidean norm, and μ is a weight value applied to the normalized constraint function gradient. The parameter μ may be a value between 0 and 1. The optimization system may be configured to use the combined gradient Δx to update the parameters of the given system (e.g., as described at block 208B of process 200 described herein with reference to FIG. 2).

FIG. 5 is a flowchart of a process 500 of optimizing a given system, according to some embodiments of the technology described herein. Process 500 may be performed by any suitable computing device. In some embodiments, process 500 may be performed by optimization system 100 described herein with reference to FIGS. 1A-1B.

Process 500 begins at block 502, where the device obtains a given system optimized using a hybrid analog-digital processor. In some embodiments, the device may be configured to obtain the optimized system by performing process 200 described herein with reference to FIG. 2. In some embodiments, the device may be configured to obtain the system after process 200 was performed by another device (e.g., optimization system 100) to optimize the system.

In some embodiments, the optimization performed at block 502 using the hybrid analog-digital processor may optimize the system faster than a digital processor. The optimization may be used as a starting point for a subsequent optimization using a digital processor that determines parameter values of the system with more precision (e.g., because the digital processor may use a number representation with a greater number of bits than the hybrid analog-digital processor). Performing the optimization at block 502 may allow a subsequent optimization performed by a digital processor to obtain optimized parameters with a fewer number of computations than if optimization were performed exclusively using a digital processor.

Next, process 500 proceeds to block 504, where the device performs a subsequent optimization of the given system using a digital processor. In some embodiments, the device may be configured to use the parameter values of the given system obtained at block 502 as initial values in the subsequent optimization. For example, the device may perform gradient descent using a digital processor (e.g., to perform matrix operations involved in the gradient descent). In some embodiments, the device may be configured to use linear programming, quadratic programming, a genetic algorithm, or another suitable optimization technique.

Next, process 500 proceeds to block 506, where the device outputs the optimized system. The optimized system may be used in an application (e.g., engine control, valve control, execution of financial trades, outputting of a navigation route, and/or other application). The process 500 may perform optimization of the system at a faster rate than optimization performed using only digital processing hardware because the initial optimization at block 502 may be performed more efficiently using a hybrid analog-digital processor and also reduce computations required by a digital processor at bock 504.

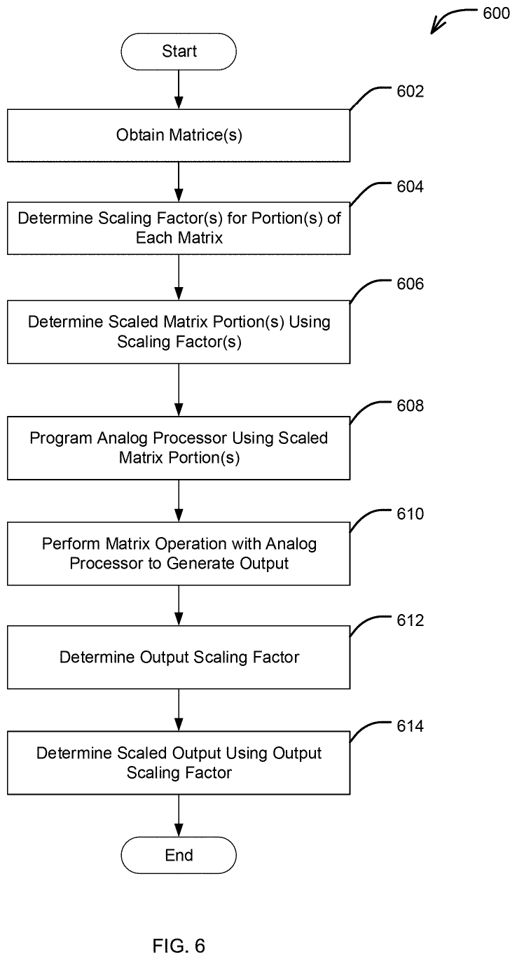

FIG. 6 is a flowchart of an example process 600 of performing a matrix operation using an analog processor, according to some embodiments of the technology described herein. The process 600 uses the ABFP representation of matrices to perform the matrix operation. In some embodiments, process 600 may be performed by optimization system 100 described herein with reference to FIGS. 1A-1B. For example, process 600 may be performed at blocks 208A of process 200 described herein with reference to FIG. 2 to determine a parameter gradient.

Process 600 begins at block 602, where the system obtains one or more matrices. For example, the matrices may consist of a matrix and a vector. To illustrate, a first matrix may be a weight matrix or portion, and a second matrix may be an input vector or portion thereof for the system. As another example, the first matrix may be control parameters (e.g., gains) of a control system, and a second matrix may be a column vector or portion thereof from an input matrix.

Next, process 600 proceeds to block 604, where the system determines a scaling factor for one or more portions of each matrix involved in the matrix operation (e.g., each matrix and/or vector). In some embodiments, the system may be configured to determine a single scaling factor for the entire matrix. For example, the system may determine a single scaling factor for an entire weight matrix. In another example, the matrix may be a vector, and the system may determine a scaling factor for the vector. In some embodiments, the system may be configured to determine different scaling factors for different portions of the matrix. For example, the system may determine a scaling factor for each row or column of the matrix. Example techniques of determining a scaling factor for a portion of a matrix are described herein in reference to scaling component 112B of FIG. 1B.

Next, process 600 proceeds to block 606, where the system determines, for each matrix, scaled matrix portion(s) using the determined scaling factor(s). In some embodiments, the system may be configured to determine: (1) scaled portion(s) of a matrix using scaling factor(s) determined for the matrix; and (2) a scaled vector using a scaling factor determined for the vector. For example, if the system determines a scaling factor for an entire matrix, the system may scale the entire matrix using the scaling factor. In another example, if the system determines a scaling factor for each row or column of a matrix, the system may scale each row or column using its respective scaling factor. Example techniques of scaling a portion of a matrix using its scaling factor are described herein in reference to scaling component 112B of FIG. 1B.

Next, process 600 proceeds to block 608, where the system programs an analog processor using the scaled matrix portion(s). In some embodiments, for each matrix, the system may be configured to program scaled portion(s) of the matrix into the analog processor. The system may be configured to program the scaled portion(s) of the matrix into the analog processor using a DAC (e.g., DAC 114 described herein with reference to FIGS. 1A-1B). In some embodiments, the system may be configured to program the scaled portion(s) of the matrix into a fixed-point representation. For example, prior to being programmed into the analog processor, the numbers of a matrix may be stored using a floating-point representation used by digital controller 112. After being programmed into the analog processor, the numbers may be stored in a fixed-point representation used by the analog processor 116. In some embodiments, the dynamic range of the fixed-point representation may be less than that of the floating-point representation.

Next, process 600 proceeds to block 610, where the system performs the matrix operation with the analog processor programmed using the scaled matrix portion(s). The analog processor may be configured to perform the matrix operation (e.g., matrix multiplication) using analog signals representing the scaled matrix portion(s) to generate an output. In some embodiments, the system may be configured to provide the output of the analog processor to an ADC (e.g., ADC 118) to be converted into a digital format (e.g., a floating-point representation).

Next, process 600 proceeds to block 612, where the system determines one or more output scaling factor. The system may be configured to determine the output scaling factor to perform an inverse of the scaling performed at block 606. In some embodiments, the system may be configured to determine an output scaling factor using input scaling factor(s). For example, the system may determine an output scaling factor as a product of input scaling factor(s). In some embodiments, the system may be configured to determine an output scaling factor for each portion of an output matrix (e.g., each row of an output matrix). For example, if at block 606 the system had scaled each row using a respective scaling factor, the system may determine an output scaling factor for each row using its respective scaling factor. In this example, the system may determine an output scaling factor for each row by multiplying the input scaling factor by a scaling factor of a vector that the row was multiplied with to obtain the output scaling factor for the row.

Next, process 600 proceeds to block 614, where the system determines a scaled output using the output scaling factor(s) determined at block 614. For example, the scaled output may be a scaled output vector obtained by multiplying each value in an output vector with a respective output scaling factor. In another example, the scaled output may be a scaled output matrix obtained by multiplying each row with a respective output scaling factor. In some embodiments, the system may be configured to accumulate the scaled output to generate an output of a matrix operation. For example, the system may add the scaled output to another matrix in which matrix operation outputs are being accumulated. In another example, the system may sum an output matrix with a bias term.

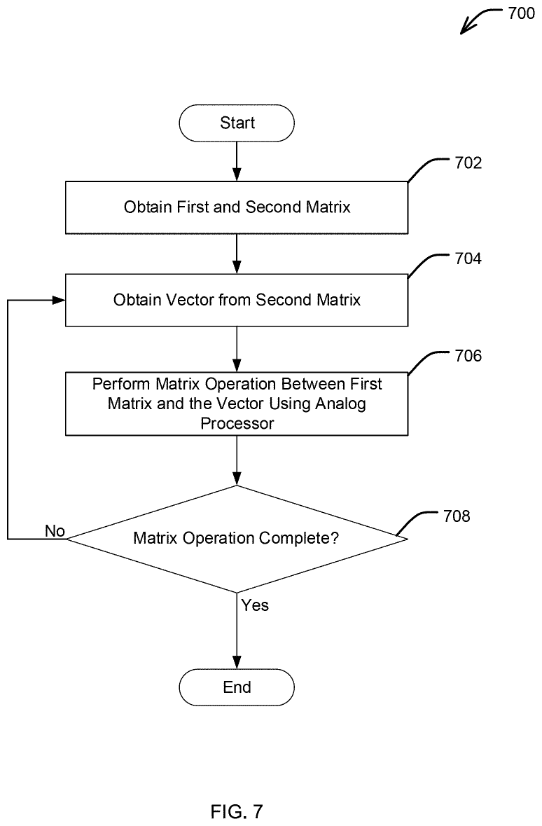

FIG. 7 is a flowchart of an example process 700 of performing a matrix operation between two matrices, according to some embodiments of the technology described herein. In some embodiments, the matrix operation may be a matrix multiplication. In some embodiments, process 700 may be performed by optimization system 100 described herein with reference to FIGS. 1A-1B. In some embodiments, process 700 may be performed as part of the acts performed at block 208A of process 200 described herein with reference to FIG. 2 to determine a parameter gradient. For example, process 700 may be performed to determine an output of a system and/or to determine the parameter gradient using the output of the system.

Process 700 begins at block 702, where the system obtains a first and second matrix. In some embodiments, the matrices may consist of parameters of a system to be optimized, and a matrix of inputs to the system. For example, the matrices may consist of a weight matrix of neural network and a vector input to the neural network, or a parameter matrix for a control system and a vector input to the control system. In some embodiments, the matrices may be portions of other matrices. For example, the system may be configured to obtain tiles of the matrices as described herein in reference to FIGS. 9A-9B. To illustrate, the first matrix may be a tile obtained from a weight matrix of a neural network, and the second matrix may be an input vector corresponding to the tile.

Next, process 700 proceeds to block 704, where the system obtains a vector from the second matrix. In some embodiments, the system may be configured to obtain the vector by obtaining a column of the second matrix. For example, the system may obtain a vector corresponding to a tile of a weight matrix.

Next, process 700 proceeds to block 706, where the system performs the matrix operation between the first matrix and the vector using an analog processor. For example, the system may perform a matrix multiplication between the first matrix and the vector. In this example, the output of the matrix multiplication may be a row of an output matrix or a portion thereof. An example technique by which the system performs the matrix operation using the analog processor is described in process 600 described herein with reference to FIG. 6.

Next, process 700 proceeds to block 708, where the system determines whether the matrix operation between the first and second matrix has been completed. In some embodiments, the system may be configured to determine whether the first and second matrix has been completed by determining whether all vectors of the second matrix have been multiplied by the first matrix. For example, the system may determine whether the first matrix has been multiplied by all columns of the second matrix. If the system determines that the matrix operation is complete, then process 700 ends. If the system determines that the matrix operation is not complete, then process 700 proceeds to block 704, where the system obtains another vector from the second matrix.

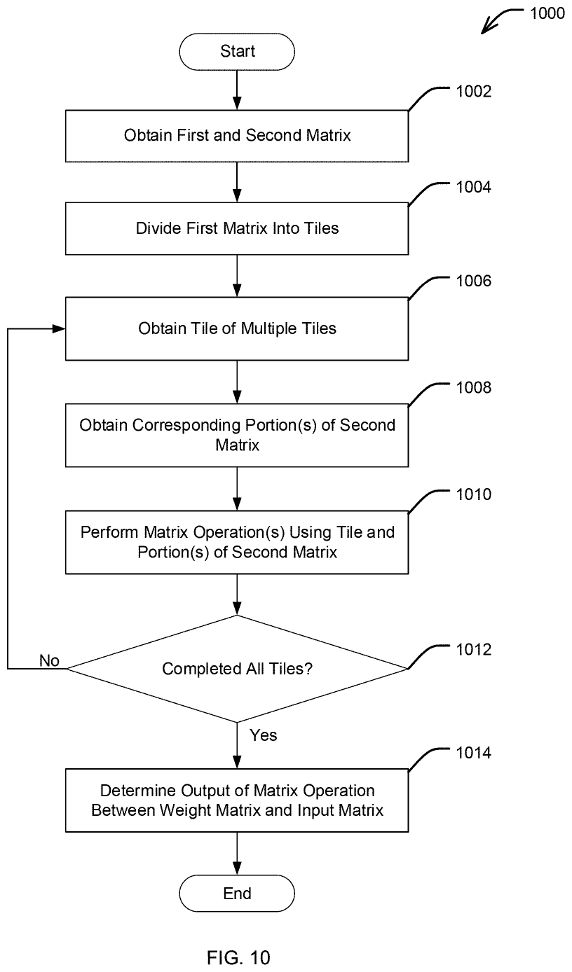

FIG. 10 is a flowchart of an example process 1000 of using tiling to perform a matrix operation, according to some embodiments of the technology described herein. Process 1000 may be performed by the optimization system 100 described herein with reference to FIGS. 1A-1B. In some embodiments, process 1000 may be performed as part of process 600 described herein with reference to FIG. 6.

Process 1000 begins at block 1002, where the system obtains a first and second matrix that are involved in a matrix operation. In some embodiments, the matrix operation may be a matrix multiplication. The matrix multiplication may be to determine an output of a system (e.g., by multiplying a parameter matrix an input matrix). For example, the first matrix may be a weight matrix for a neural network and the second matrix may be an input matrix for the neural network. As another example, the first matrix may be a parameter matrix for a control system and the second matrix may be input to the control system.

Next, process 1000 proceeds to block 1004, where the system divides the first matrix into multiple tiles. For example, the system may divide a weight matrix into multiple tiles. An example technique for dividing a matrix into tiles is described herein with reference to FIGS. 9A-9B.

Next, process 1000 proceeds to block 1006, where the system obtains a tile of the multiple tiles. After selecting a tile at block 1006, process 1000 proceeds to block 1008, where the system obtains corresponding portions of the second matrix. In some embodiments, the corresponding portion(s) of the second matrix may be one or more vectors of the second matrix. For example, the corresponding portion(s) may be one or more column vectors from the second matrix. The column vector(s) may be those that align with the tile matrix for a matrix multiplication.

Next, process 1000 proceeds to block 1008, where the system performs one or more matrix operations using the tile and the portion(s) of the second matrix. In some embodiments, the system may be configured to perform process 700 described herein with reference to FIG. 7 to perform the matrix operation. In embodiments in which the portion(s) of the second matrix are vector(s) (e.g., column vector(s)) from the second matrix, the system may perform the matrix multiplication in multiple passes. In each pass, the system may perform a matrix multiplication between the tile and a vector (e.g., by programming an analog processor with a scaled tile and scaled vector to obtain an output of the matrix operation.) In some embodiments, the system may be configured to perform the operation in a single pass. For example, the system may program the tile and the portion(s) of the second matrix into an analog processor and obtain an output of the matrix operation performed by the analog processor.

Next, process 1000 proceeds to block 1012, where the system determines whether all the tiles of the first matrix have been completed. The system may be configured to determine whether all the tiles have been completed by determining whether the matrix operations (e.g., multiplications) for each tile have been completed. If the system determines that the tiles have not been completed, then process 1000 proceeds to block 1006, where the system obtains another tile.

If the system determines that the tiles have been completed, then process 1000 proceeds to block 1014, where the system determines an output of the matrix operation between the weight matrix and an input matrix. In some embodiments, the system may be configured to accumulate results of matrix operation(s) performed for the tiles into an output matrix. The system may be configured to initialize an output matrix. For example, for a multiplication of a 4×4 matrix with a 4×2 matrix, the system may initialize 4×2 matrix. In this example, the system may accumulate an output of each matrix operation in the 4×2 matrix (e.g., by adding the output of the matrix operation with a corresponding portion of the output matrix).

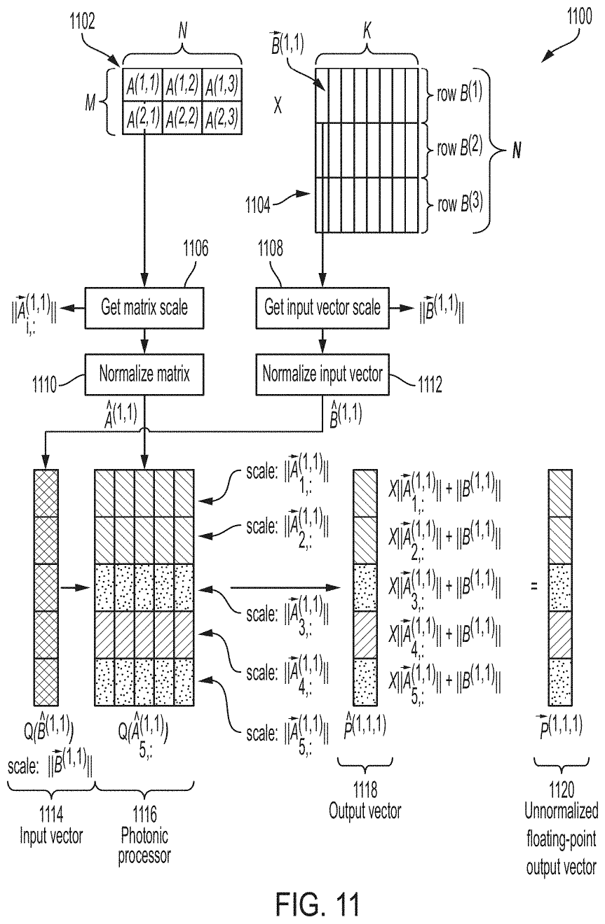

FIG. 11 is a diagram 1100 illustrating performance of a matrix multiplication operation using the ABFP representation, according to some embodiments of the technology described herein. The matrix multiplication illustrated in FIG. 11 may, for example, be performed by performing process 600 described herein with reference to FIG. 6. In the example of FIG. 11, the analog processor is a photonic processor. In some embodiments, a different type of analog processor may be used instead of a photonic processor in the diagram 1100 illustrated by FIG. 11.

The diagram 1100 shows a matrix operation in which the matrix 1102 is to be multiplied by a matrix 1104. The matrix 1002 is divided into multiple tiles labeled A^{(1,1)}, A^{(1,2)}, A^{(1,3)}, A^{(2,1)}, A^{(2,2)}, A^{(2,3)}. The diagram 1000 shows a multiplication performed between the tile matrix A^{(1,1)} from matrix 1002 and a corresponding column vector B^{(1,1)} from the matrix 1004. At block 1106, a scaling factor (also referred to as “scale”) is determined for the tile A^{(1,1)}, and at block 1108 a scale is determined for the input vector B^{(1,1)}. Although the embodiment of FIG. 11 shows that a single scale is determined for the tile at block 1106, in some embodiments the system may determine multiple scales for the tile matrix. For example, the system may determine a scale for each row of the tile. Next, at block 1110 the tile matrix is normalized using the scale determined at block 806, and the input vector is normalized using the scale determined at block 1108. The tile matrix may be normalized by determining a scaled tile matrix using the scale obtained at block 806 as described at block 1106 of process 1100. Similarly, the input vector may be normalized by determined a scaled input vector using the scale obtained at block 808 as described at block 1106 of process 1100.

The normalized input vector is programmed into the photonic processor as illustrated at reference 1114, and the normalized tiled matrix is programmed into the photonic processor as illustrated at reference 1116. The tile matrix and the input vector may be programmed into the photonic processor using a fixed-point representation. The tile matrix and input vector may be programmed into the photonic processor using a DAC. The photonic processor performs a multiplication between the normalized tile matrix and input vector to obtain the output vector 1118. The output vector 1118 may be obtained by inputting an analog output of the photonic processor into an ADC to obtain the output vector 1118 represented using a floating-point representation. Output scaling factors are then used to determine the unnormalized output vector 1120 from the output vector 1118 (e.g., as described at blocks 612-614 of process 600). The unnormalized output vector 1120 may then be accumulated into an output matrix for the matrix operation between matrix 1102 and matrix 1104. For example, the vector 1120 may be stored in a portion of a column of the output matrix. The process illustrated by diagram 1100 may be repeated for each tile of matrix 1102 and corresponding portion(s) of matrix 1104 until the multiplication is completed.

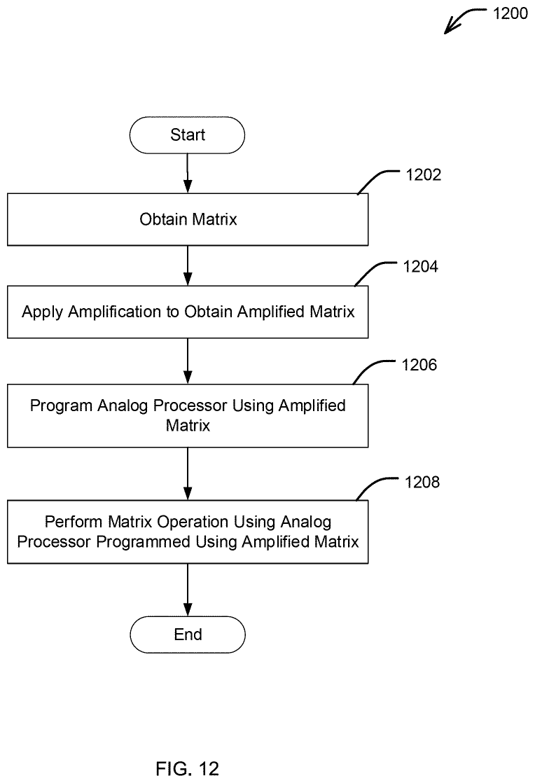

FIG. 12 is a flowchart of an example process 1200 of performing overamplification, according to some embodiments of the technology described herein. Process 1200 may be performed by optimization system 100 described herein with reference to FIGS. 1A-1B. Process 1200 may be performed as part of process 600 described herein with reference to FIG. 6. For example, process 1200 may be performed as part of programming an analog processor at block 608 of process 600. As described herein, overamplification may allow the system to capture lower significant bits of an output of an operation that would otherwise not be captured. For example, an analog processor of the system may use a fixed-bit representation of numbers that is limited to a constant number of bits. In this example, the overamplification may allow the analog processor to capture additional lower significant bits in the fixed-bit representation.

Process 1200 begins at block 1202, where the system obtains a matrix. The system may be configured to obtain a matrix. For example, the system may obtain a matrix as described at blocks 602-606 of process 600 described herein with reference to FIG. 6. The matrix may be a scaled matrix or portion thereof (e.g., a tile or vector). In some embodiments, the system may be configured to obtain a matrix without any scaling applied to the matrix.

Next, process 1200 proceeds to block 1204, where the system applies amplification to the matrix to obtain an amplified matrix. In some embodiments, the system may be configured to apply amplification to a matrix by multiplying the matrix by a gain factor prior to programming the analog processor. For example, the system may multiply the matrix by a gain factor of 2, 4, 8, 16, 32, 64, 128, or another exponent of 2. To illustrate, the system may be limited to b bits for representation of a number output by the analog processor (e.g., through an ADC). A gain factor of 1 results in obtaining b bits of the output starting from the most significant bit, a gain factor of 2 results in obtaining b bits of the output starting from the 2^{nd} most significant bit, and a gain factor of 3 results in obtaining b bits of the output starting from the 3^{rd} most significant bit. In this manner, the system may increase lower significant bits captured in an output at the expense of higher significant bits. In some embodiments, a distribution of outputs of a machine learning model (e.g., layer outputs and inference outputs of a neural network) may not reach one or more of the most significant bits. Thus, in such embodiments, capturing lower significant bit(s) at the expense of high significant bit(s) during training of a machine learning model and/or inference may improve the performance of the machine learning model. Accordingly, overamplification may be used to capture additional lower significant bit(s).

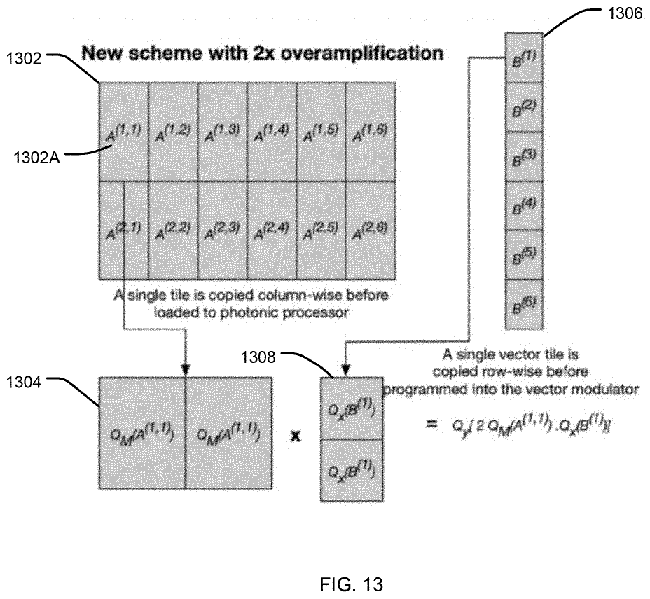

In some embodiments, the system may be configured to apply amplification by: (1) obtaining a copy of the matrix; and (2) appending the copy of the matrix to the matrix. FIG. 13 illustrates amplification by copying of a matrix, according to some embodiments of the technology described herein. In the example of FIG. 13, the matrix tile 1302A of the matrix 1302 is the matrix that is to be loaded into an analog processor (e.g., a photonic processor) to perform a matrix operation. As shown in FIG. 13, the system copies the tile 1302A column-wise to obtain an amplified matrix. The amplified matrix 1304 is programmed into the analog processor. In the example of FIG. 13, the tile 1302A is to be multiplied by the vector tile 1306. The system makes a copy of the vector tile 1306 row-wise to obtain an amplified vector tile.

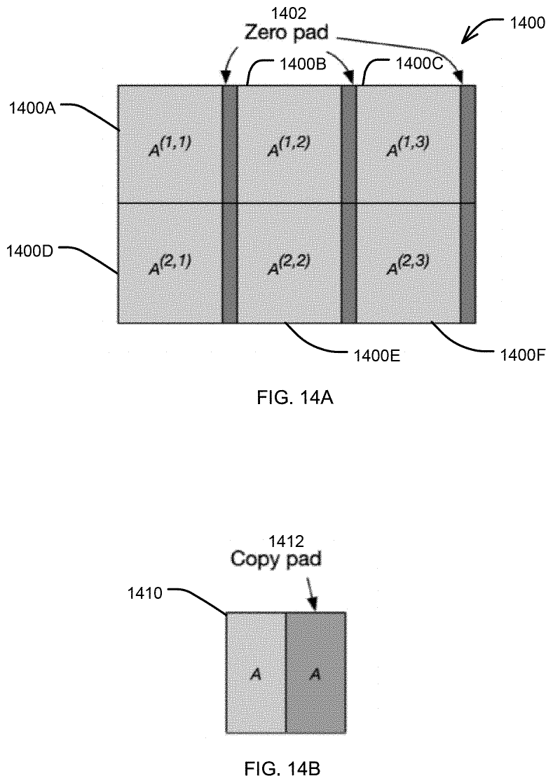

In some embodiments, the system may be configured to apply amplification by distributing a zero pad among different portions of a matrix. The size of an analog processor may be large relative to a size of the matrix. The matrix may thus be padded to fill the input of the analog processor. FIG. 14A is a diagram illustrating amplification by distribution of zero pads among different tiles of a matrix, according to some embodiments of the technology described herein. As shown in FIG. 14A, the matrix 1400 is divided into tiles 1400A, 1400B, 1400C, 1400D, 1400E, 1400F. The system distributes zeroes of a zero pad 1402 among the tiles 1400A, 1400B, 1400C, 1400D, 1400E, 1400F. The system may be configured to distribute the zero pad 1402 among the tiles 1400A, 1400B, 1400C, 1400D, 1400E, 1400F instead of appending the zero pad to the end of matrix 1400 to obtain an amplified matrix.

FIG. 14B is a diagram illustrating amplification by using a copy of a matrix as a pad, according to some embodiments of the technology described herein. In the example of FIG. 14B, instead of using a zero pad, the system uses a copy of the matrix 1410 as the pad 1412 to obtain an amplification of the matrix. The system may be configured to determine the amplification factor based on how many copies the system copies.

Returning again to FIG. 12, after obtaining the amplified matrix at block 1204, process 1200 proceeds to block 1206, where the system programs the analog processor using the amplified matrix. After programming the analog processor using the amplified matrix, process 1200 proceeds to block 1208, where the system performs the matrix operation using the analog processor programmed using the amplified matrix. The system may be configured to obtain an analog output, and provide the analog output to an ADC to obtain a digital representation of the output.

In some embodiments, the system may be configured to use any combination of one or more of the overamplification techniques described herein. For example, the system may apply a gain factor in addition to copying a matrix. In another example, the system may apply a gain factor in addition to distributing a zero pad among matrix tiles. In another example, the system may copy a matrix in addition to distributing a zero pad among matrix tiles. In some embodiments, the system may be configured to perform overamplification by repeating an operation multiple times. In such embodiments, the system may be configured to accumulate results of the multiple operations and average the results. In some embodiments, the system may be configured to average the results using a digital accumulator. In some embodiments, the system may be configured to average the results using an analog accumulator (e.g., a capacitor).

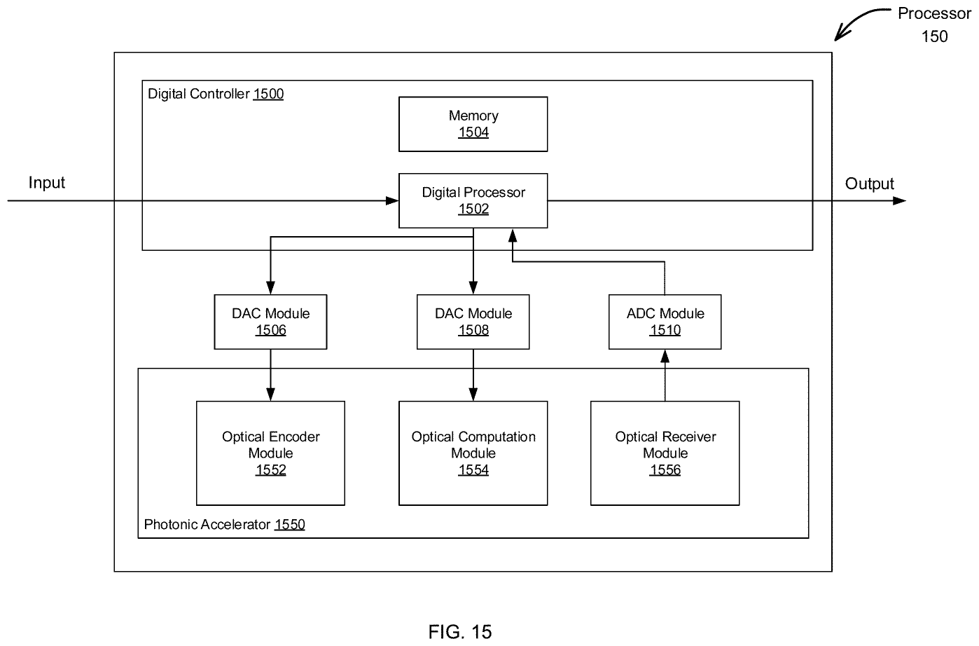

FIG. 15 is an example hybrid analog-digital processor 150 that may be used in some embodiments of the technology described herein. The processor 150 may be hybrid analog-digital processor 110 described herein with reference to FIGS. 1A-1B. The example processor 150 of FIG. 15 is a hybrid analog-digital processor implemented using photonic circuits. As shown in FIG. 15, the processor 150 includes a digital controller 1500, digital-to-analog converter (DAC) modules 1506, 1508, an ADC module 1510, and a photonic accelerator 1550. The photonic accelerator 1550 may be used as the analog processor 116 in the hybrid analog-digital processor 110 of FIGS. 1A-1B. Digital controller 1500 operates in the digital domain and photonic accelerator 1550 operates in the analog photonic domain. Digital controller 1500 includes a digital processor 1502 and memory 1504. Photonic accelerator 1550 includes an optical encoder module 1552, an optical computation module 1554, and an optical receiver module 1556. DAC modules 106, 108 convert digital data to analog signals. ADC module 1510 converts analog signals to digital values. Thus, the DAC/ADC modules provide an interface between the digital domain and the analog domain used by the processor 150. For example, DAC module 1506 may produce N analog signals (one for each entry in an input vector), a DAC module 1508 may produce N×N analog signals (e.g., one for each entry of a matrix storing neural network parameters), and ADC module 1510 may receive analog signals (e.g., one for each entry of an output vector).

The processor 150 may be configured to generate or receive (e.g., from an external device) an input vector of a set of input bit strings and output an output vector of a set of output bit strings. For example, if the input vector is an N-dimensional vector, the input vector may be represented by N bit strings, each bit string representing a respective component of the vector. An input bit string may be an electrical signal and an output bit string may be transmitted as an electrical signal (e.g., to an external device). In some embodiments, the digital process 1502 does not necessarily output an output bit string after every process iteration. Instead, the digital processor 1502 may use one or more output bit strings to determine a new input bit string to feed through the components of the processor 150. In some embodiments, the output bit string itself may be used as the input bit string for a subsequent process iteration. In some embodiments, multiple output bit streams are combined in various ways to determine a subsequent input bit string. For example, one or more output bit strings may be summed together as part of the determination of the subsequent input bit string.

DAC module 1506 may be configured to convert the input bit strings into analog signals. The optical encoder module 1552 may be configured to convert the analog signals into optically encoded information to be processed by the optical computation module 1554. The information may be encoded in the amplitude, phase, and/or frequency of an optical pulse. Accordingly, optical encoder module 1552 may include optical amplitude modulators, optical phase modulators and/or optical frequency modulators. In some embodiments, the optical signal represents the value and sign of the associated bit string as an amplitude and a phase of an optical pulse. In some embodiments, the phase may be limited to a binary choice of either a zero phase shift or a π phase shift, representing a positive and negative value, respectively. Some embodiments are not limited to real input vector values. Complex vector components may be represented by, for example, using more than two phase values when encoding the optical signal.

The optical encoder module 1552 may be configured to output N separate optical pulses that are transmitted to the optical computation module 1554. Each output of the optical encoder module 1552 may be coupled one-to-one to an input of the optical computation module 1554. In some embodiments, the optical encoder module 1552 may be disposed on the same substrate as the optical computation module 1554 (e.g., the optical encoder 1652 and the optical computation module 1554 are on the same chip). The optical signals may be transmitted from the optical encoder module 1552 to the optical computation module 1554 in waveguides, such as silicon photonic waveguides. In some embodiments, the optical encoder module 1652 may be on a separate substrate from the optical computation module 1554. The optical signals may be transmitted from the optical encoder module 1552 to optical computation module 1554 with optical fibers.

The optical computation module 1554 may be configured to perform multiplication of an input vector ‘X’ by a matrix ‘A’. In some embodiments, the optical computation module 1554 includes multiple optical multipliers each configured to perform a scalar multiplication between an entry of the input vector and an entry of matrix ‘A’ in the optical domain. Optionally, optical computation module 1554 may further include optical adders for adding the results of the scalar multiplications to one another in the optical domain. In some embodiments, the additions may be performed electrically. For example, optical receiver module 1556 may produce a voltage resulting from the integration (over time) of a photocurrent received from a photodetector.

The optical computation module 1554 may be configured to output N optical pulses that are transmitted to the optical receiver module 1556. Each output of the optical computation module 1554 is coupled one-to-one to an input of the optical receiver module 1556. In some embodiments, the optical computation module 1554 may be on the same substrate as the optical receiver module 1556 (e.g., the optical computation module 1554 and the optical receiver module 1556 are on the same chip). The optical signals may be transmitted from the optical computation module 1554 to the optical receiver module 1556 in silicon photonic waveguides. In some embodiments, the optical computation module 1554 may be disposed on a separate substrate from the optical receiver module 1556. The optical signals may be transmitted from the optical computation module 1554 to the optical receiver module 1556 using optical fibers.

The optical receiver module 1556 may be configured to receive the N optical pulses from the optical computation module 1554. Each of the optical pulses may be converted to an electrical analog signal. In some embodiments, the intensity and phase of each of the optical pulses may be detected by optical detectors within the optical receiver module. The electrical signals representing those measured values may then be converted into the digital domain using ADC module 1510, and provided back to the digital process 1502.

The digital processor 1502 may be configured to control the optical encoder module 1552, the optical computation module 1554 and the optical receiver module 1556. The memory 1504 may be configured to store input and output bit strings and measurement results from the optical receiver module 1556. The memory 1504 also stores executable instructions that, when executed by the digital processor 1502, control the optical encoder module 1552, optical computation module 1554, and optical receiver module 1556. The memory 1504 may also include executable instructions that cause the digital processor 1502 to determine a new input vector to send to the optical encoder based on a collection of one or more output vectors determined by the measurement performed by the optical receiver module 1556. In this way, the digital processor 1502 may be configured to control an iterative process by which an input vector is multiplied by multiple matrices by adjusting the settings of the optical computation module 1554 and feeding detection information from the optical receive module 1556 back to the optical encoder 1552. Thus, the output vector transmitted by the processor 150 to an external device may be the result of multiple matrix multiplications, not simply a single matrix multiplication.

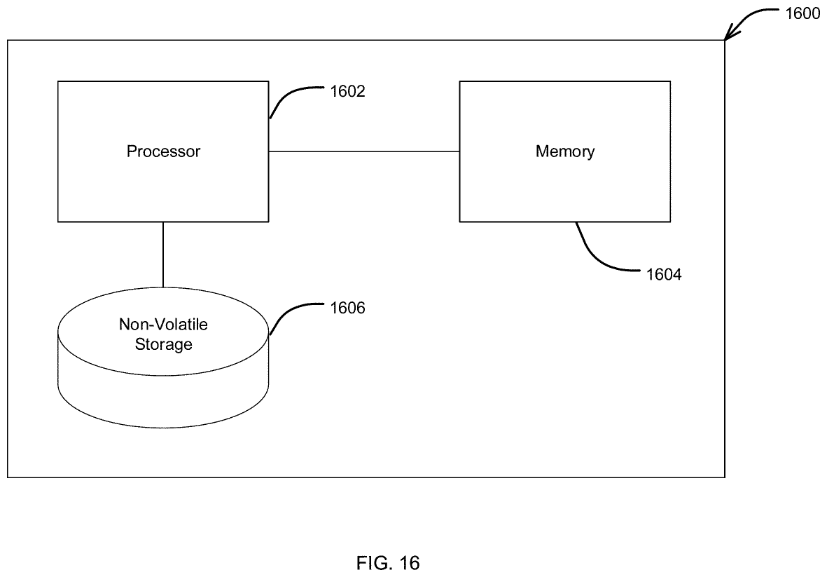

FIG. 16 is an example computer system that may be used to implement some embodiments of the technology described herein. The computing device 1600 may include one or more computer hardware processors 1602 and non-transitory computer-readable storage media (e.g., memory 1604 and one or more non-volatile storage devices 1606). The processor(s) 1602 may control writing data to and reading data from (1) the memory 1604; and (2) the non-volatile storage device(s) 1606. To perform any of the functionality described herein, the processor(s) 1602 may execute one or more processor-executable instructions stored in one or more non-transitory computer-readable storage media (e.g., the memory 1604), which may serve as non-transitory computer-readable storage media storing processor-executable instructions for execution by the processor(s) 1602.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method of using a hybrid analog-digital processor to optimize a system for an objective under at least one constraint, the hybrid analog-digital analog processor comprising a digital controller and an analog processor, the method comprising:
using the hybrid analog-digital processor to perform:
obtaining an objective function associated with the objective, the objective function relating sets of parameter values of the system to values providing a measure of performance of the system; and
optimizing parameters of the system, the optimizing comprising:
determining, using the analog processor, a parameter gradient for parameter values of the system based on the objective function and the at least one constraint; and
updating the parameter values of the system using the parameter gradient.

2. The method of claim 1, wherein determining, using the analog processor, the parameter gradient for the parameter values based on the objective function and the at least one constraint comprises:
determining, using the analog processor, a plurality of outputs of the system when configured with the parameter values; and
determining, using the analog processor, the parameter gradient using the plurality of outputs of the system configured with the parameter values.

3. The method of claim 1, wherein determining, using the analog processor, the parameter gradient for the parameter values based on the objective function and the at least one constraint comprises:
performing, using the analog processor, at least one matrix operation to obtain at least one output of the at least one matrix operation; and
determining the parameter gradient using the at least one output of the at least one matrix operation.

4. The method of claim 3, wherein performing, using the analog processor, the at least one matrix operation comprises:
determining a scaling factor for a portion of a matrix involved in the at least one matrix operation;
scaling the portion of the matrix using the scaling factor to obtain a scaled portion of the matrix;
programming the analog processor using the scaled portion of the matrix; and
performing, by the analog processor programmed using the scaled the portion of the matrix, the at least one matrix operation to obtain the at least one output of the at least one matrix operation.

5. The method of claim 1, wherein the at least one constraint comprises at least one constraint function and the method further comprises:
generating a combined function using the objective function and the at least one constraint function;
wherein determining, using the analog processor, the parameter gradient for the parameter values based on the objective function and the at least one constraint comprises:
determining a gradient of the combined function for the parameter values.

6. The method of claim 1, wherein:
the at least one constraint comprises at least one constraint function; and
determining, using the analog processor, the parameter gradient for the parameter values based on the objective function and the at least one constraint comprises:
determining a gradient of the objective function for the parameter values;
determining a gradient of the at least one constraint function for the parameter values; and
determining the parameter gradient using the gradient of the objective function and the gradient of the at least one constraint function.

7. The method of claim 6, wherein determining the parameter gradient using the gradient of the objective function and the gradient of the at least one constraint function comprises:
determining a normalization of the gradient of the objective function;
determining a normalization of the gradient of the at least one constraint function; and
determining the parameter gradient using normalizations of the gradient of the objective function and the gradient of the at least one constraint function.

8. The method of claim 1, wherein the at least one constraint comprises at least one inequality constraint.

9. The method of claim 1, wherein:
the at least one constraint comprises a plurality of constraints represented by a plurality of constraint functions; and
determining, using the analog processor, the parameter gradient for the parameter values comprises:
generating a barrier function using the plurality of constraint functions;
determining a gradient of the objective function for the parameter values;
determining a gradient of the barrier function for the parameter values; and
determining the parameter gradient using the gradient of the objective function and the gradient of the barrier function.

10. The method of claim 9, wherein generating the barrier function using the plurality of constraints comprises generating a logarithmic barrier function.

11. The method of claim 1, further comprising:
after optimizing the parameter values of the system, performing a subsequent optimization on the parameter values of the system using a digital processor.

12. The method of claim 1, wherein the system is a machine learning system, and the objective is a task to be performed by the machine learning system.

13. An optimization system for optimizing a system for an objective under at least one constraint, the optimization system comprising:
a hybrid analog-digital processor comprising a digital controller and an analog processor, the hybrid analog-digital processor configured to:
obtain an objective function associated with the objective, the objective function relating sets of parameter values of the system to values providing a measure of performance of the system; and
optimize parameters of the system, the optimizing comprising:
determining, using the analog processor, a parameter gradient for parameter values of the system based on the objective function and the at least one constraint; and
updating the parameter values of the system using the parameter gradient.

14. The optimization system of claim 13, wherein determining, using the analog processor, the parameter gradient for the parameter values based on the objective function and the at least one constraint comprises:
determining, using the analog processor, a plurality of outputs of the system when configured with the parameter values; and
determining, using the analog processor, the parameter gradient using the plurality of outputs of the system configured with the parameter values.

15. The optimization system of claim 13, wherein determining, using the analog processor, the parameter gradient for the parameter values based on the objective function and the at least one constraint comprises:
performing, using the analog processor, at least one matrix operation to obtain at least one output of the at least one matrix operation; and
determining the parameter gradient using the at least one output of the at least one matrix operation.

16. The optimization system of claim 15, wherein performing, using the analog processor, the at least one matrix operation comprises:
determining a scaling factor for a portion of a matrix involved in the at least one matrix operation;
scaling the portion of the matrix using the scaling factor to obtain a scaled portion of the matrix;
programming the analog processor using the scaled portion of the matrix; and
performing, by the analog processor programmed using the scaled the portion of the matrix, the at least one matrix operation to obtain the at least one output of the at least one matrix operation.

17. The optimization system of claim 13, wherein the at least one constraint comprises at least one constraint function and the hybrid analog-digital processor is further configured to:
generate a combined function using the objective function and the at least one constraint function;
wherein determining, using the analog processor, the parameter gradient for the parameter values based on the objective function and the at least one constraint comprises:
determining a gradient of the combined function for the parameter values.

18. The optimization system of claim 13, wherein:
the at least one constraint comprises at least one constraint function; and
determining, using the analog processor, the parameter gradient for the parameter values based on the objective function and the at least one constraint comprises:
determining a gradient of the objective function for the parameter values;
determining a gradient of the at least one constraint function for the parameter values; and
determining the parameter gradient using the gradient of the objective function and the gradient of the at least one constraint function.

19. The optimization system of claim 13, wherein:
the at least one constraint comprises a plurality of constraints represented by a plurality of constraint functions; and
determining, using the analog processor, the parameter gradient for the parameter values comprises:
generating a barrier function using the plurality of constraint functions;
determining a gradient of the objective function for the parameter values;
determining a gradient of the barrier function for the parameter values; and
determining the parameter gradient using the gradient of the objective function and the gradient of the barrier function.

20. A non-transitory computer-readable storage medium storing instructions that, when executed by a hybrid analog-digital processor comprising a digital controller and an analog processor, cause the hybrid analog-digital processor to perform a method of optimizing a system for an objective under at least one constraint, the method comprising:
obtaining an objective function associated with the objective, the objective function relating sets of parameter values of the system to values providing a measure of performance of the system; and
optimizing parameters of the system, the optimizing comprising:
determining, using the analog processor, a parameter gradient for parameter values of the system based on the objective function and the at least one constraint; and
updating the parameter values of the system using the parameter gradient.
